(19) United States
(12) Patent Application Publication
(10) Pub. No.: US 2026/0367756 A1
(43) Pub. Date: Nov. 19, 2026

(54) User Interface for Simplified and Integrated Interaction with Multiple Applications

(71) Applicant: Google LLC, Mountain View, CA (US)

(72) Inventors: Tim Wantland, Pacifica, CA (US); Ryan Bryce Connolly, Sunnyvale, CA (US); Christina Buquid, Irvine, CA (US); Jeffery Weber, Longmont, CO (US); Gus Winkelman, Soquel, CA (US)

(73) Assignee: Google LLC, Mountain View, CA (US)

(21) Appl. No.: 19/475,871

(22) PCT Filed: Nov. 3, 2023
(86) PCT No.: PCT/US2023/078702

§ 371 Date: Oct. 16, 2025

(51) Int. Cl. G06F 3/0482; G06F 3/0484; G06F 9/451

(52) U.S. Cl. CPC G06F 3/0482; G06F 3/0484; G06F 9/451

(57) ABSTRACT

This document describes techniques and systems enabling a user interface for simplified and integrated interaction with multiple applications. The techniques and systems enable users to interact with reduced-function-set versions of multiple different software applications through one interface. Through this one interface, users are enabled to easily navigate between functions of these different software applications, easily use these functions, and integrate interactions by causing content changes made to one of the reduced-function-set versions to be reflected across another, different software application. By so doing, users may quickly access, alter, or interact with multiple software applications, even with a single interaction.

### BACKGROUND

Many users access software applications through multiple different user interfaces. These interfaces often are complex or vary substantially from each other, having different workflows, layouts, navigation systems, and terminologies. This can be confusing and inefficient for users. As a result, users often struggle to navigate and interact with different software applications, which may impact their ability to complete tasks that use more than one software application.

This background description is provided for the purpose of generally presenting the context of the disclosure. Unless otherwise indicated herein, material described in this section is neither expressly nor impliedly admitted to be prior art to the present disclosure or the appended claims.

### SUMMARY

This document describes techniques and systems enabling a user interface for simplified and integrated interaction with multiple applications. The techniques and systems enable users to interact with reduced-function-set versions of multiple different software applications through one interface. Through this one interface, users are enabled to easily navigate between functions of these different software applications, easily use these functions, and integrate interactions by causing content changes made to one of the reduced-function-set versions to be reflected across another, different software application. By so doing, users may quickly access, alter, or interact with multiple software applications, even with a single interaction.

For example, a method is described that presents, by a user interface application and within a user interface, two or more selectable controls within a control region of the user interface. The two or more selectable controls are associated with two or more software applications, respectively. The method enables selection of the two or more selectable controls and, responsive to a first selection of a first selected one of the two or more selectable controls, presents, within a first region of the user interface, a first reduced-function-set version of a first full-function-set version associated with a first full instance of a first software application. The method responds to a second selection of a second selected one of the two or more selectable controls and presents, within a second region of the user interface, a second reduced-function-set version of a second full-function-set version associated with a second full instance of a second software application. The method enables interaction through the first region of the user interface, with a first content presented through the first reduced-function-set version of the first software application. The method alters a second content of the second reduced-function-set version of the second software application based on an interaction with the first content enabled through the first reduced-function-set version of the first software application.

This document also describes computer-readable media having instructions for performing the above-summarized method and other methods set forth herein, as well as systems and means for performing these methods.

This summary is provided to introduce simplified concepts for a user interface for simplified and integrated interaction with multiple applications, which is further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

The details of one or more aspects of a user interface for simplified and integrated interaction with multiple applications are described in this document with reference to the following drawings.

The same numbers are used throughout the drawings to reference like features and components.

FIG. 1 illustrates an implementation of a user equipment, which includes a notification manager and user interface application.

FIG. 2 illustrates an example of a user interface with selectable controls.

FIG. 3 illustrates a user interface and an association between multiple software applications.

FIG. 4 illustrates an example implementation of changing the user interface with selectable (e.g., drag and drop) controls.

FIG. 5 illustrates an example implementation of adding content.

FIG. 6 illustrates an example implementation of deleting a singular item in one software application, in response to which techniques cause a change to another software application.

FIG. 7 illustrates example full and reduced-function versions of a software application.

FIG. 8 illustrates, within a single user interface, passing information associated with an interaction with a first content associated with a first software application to a second software application.

FIG. 9 illustrates presentation of content associated with an application and enabling selection of the content on the user interface.

FIG. 10 illustrates a user interface application presenting reduced versions of instances of content.

FIG. 11 illustrates an example illustration of the user interface responding to a selectable control.

FIG. 12 illustrates an example illustration of different sizes of different regions in the user interface.

FIG. 13 illustrates an example implementation of additional content and functions from software applications.

FIG. 14 illustrates an example illustration of a selectable function of a software application.

FIG. 15 illustrates visual information from several software applications.

FIG. 16 illustrates an example environment in which techniques for a multi-application user interface for prioritizing notifications can be implemented.

FIG. 17 illustrates an example user interface with five prioritized notifications set forth in FIG. 16.

FIG. 18 illustrates an example implementation of the user interface of FIG. 17.

FIG. 19 illustrates another example implementation of the user interface of FIG. 17.

FIG. 20 illustrates another example of the user interface with the five prioritized notifications set forth in FIG. 16 along with a sixth prioritized notification.

FIG. 21 illustrates an example environment in which techniques for enabling a user interface integrating disparate software applications through inter-process communication mechanisms can be implemented.

FIG. 22 illustrates two example user interfaces in which techniques for enabling a user interface integrating disparate software applications through inter-process communication mechanisms can be implemented.

FIG. 23 illustrates another example user interface in which techniques for enabling a user interface integrating disparate software applications through inter-process communication mechanisms can be implemented.

FIG. 24 illustrates an example method for a machine-learned model.

FIG. 25 illustrates a block diagram of an example computing device and training computing system.

FIG. 26 illustrates a block diagram of a training process.

FIG. 27 illustrates an example method enabling a user interface for integrating disparate software applications through inter-process communication mechanisms.

FIG. 28 illustrates an example method enabling a user interface for simplified and integrated interaction with multiple applications.

FIG. 29 illustrates an example method enabling a multi-application user interface for prioritizing notifications.

### DETAILED DESCRIPTION

### Overview

This document describes techniques and systems enabling a user interface for simplified and integrated interaction with multiple applications. The techniques and systems enable users to interact with reduced-function-set versions (e.g., versions that have a subset of functionality of a corresponding full-function-set version) of multiple different software applications through one interface. Through this one interface, users are enabled to easily navigate between functions of those different software applications, easily use these functions, and integrate interactions by causing content changes made to one of the reduced-function-set versions to be reflected across multiple different software applications. By so doing, users may quickly access, alter, or interact with multiple software applications, even with a single interaction. The techniques and systems therefore assist a user with inputting to multiple software applications, both by way of an interface that assists the user, and with functionality that allows the multiple software applications to interact based on user input received from the user.

Assume, for example, that there is a user who is a marketing manager responsible for handling several projects at once. One of the recent projects the user has been working on is a social-media marketing campaign for a new product launch. The project requires them to use a customer-relationship management application (relationship app) to keep track of customer interactions, a social media application to schedule posts and monitor engagement, and an email application to communicate with their team and clients. Each application has its own interface, navigation system, and terminology, making it difficult for the user to switch between them seamlessly. The user spends a lot of time trying to figure out how to accomplish simple tasks, such as creating a new contact in the relationship app, scheduling a post on social media, or drafting an email to a client, thus finding themselves wasting time on administrative tasks. This waste of time, and potentially lost information, confusion, and the like, may lead to failure of the marketing campaign or delay of a product launch. In this example, and many other examples, the different interfaces, navigation systems, and terminologies of the applications confuse and overwhelm the user, leading to mistakes and delays.

In contrast, consider the disclosed techniques, which simplify and integrate interactions with multiple software applications. The techniques provide a more-efficient and user-friendly way for users to integrate interactions across multiple applications, thereby reducing the complexity of projects and simplifying the way that users interact with their software applications.

Similarly, consider a user who needs to complete a complex project for work that involves using multiple software applications, including a project management application, a team communication application (e.g., a Short Messaging Service (SMS) application or a chat application), and a word-processing application. Throughout the day, the user needs to use all three of the applications, often needing to switch to different interfaces and applications. However, with the disclosed techniques, which enable simplified and integrated interaction across multiple applications, the user can access all these applications through one interface. The interface displays a simplified and reduced-function-set version of each application, allowing the user to quickly navigate between them and use their essential features. The user can easily move files from the word-processing application to the project management application, update task status in the project management application and share the status with the team communication application, and see real-time updates from the team communication application displayed in the interface. The user can use the word-processing application to write and edit documents and then share them with a team through the team communication application, all with a click of a single button (or even without an explicit selection). When all these applications are integrated into a single user interface, the user can accomplish a task for the project in a single interaction without the need to switch between multiple applications or waste time on or add visual clutter with unnecessary features.

This is but one example of how the described techniques and devices may be used to simplify and integrate interactions between multiple software applications. Other examples and implementations are described throughout this document. The document now turns to an example operating environment, after which example devices, methods, and systems are described.

### Operating Environment

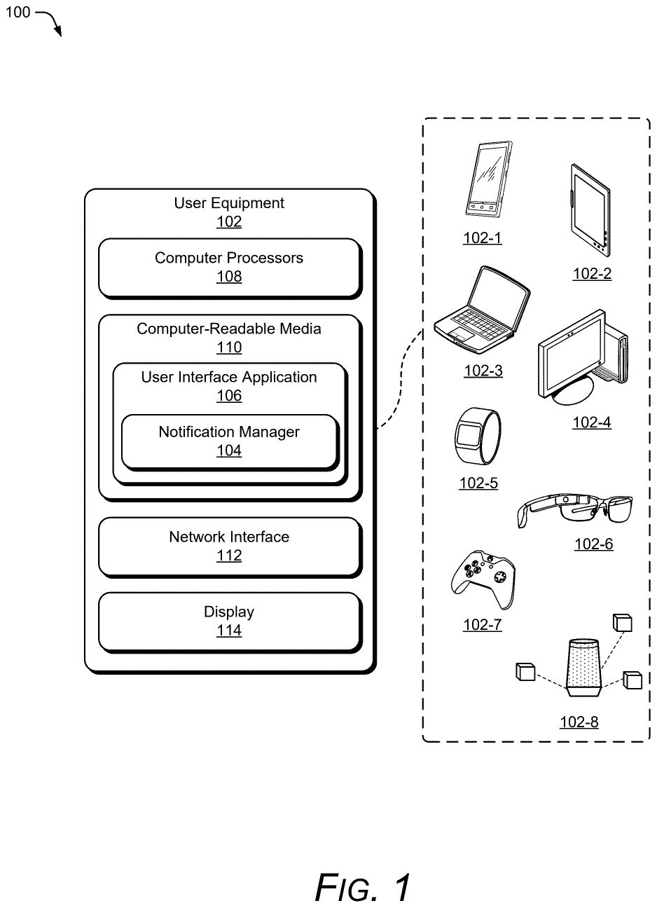

Consider FIG. 1, which illustrates an example implementation 100 of a user equipment (UE) 102 that includes a notification manager 104 and user interface application 106 and that can implement techniques for a user interface for simplified and integrated interaction with multiple applications. The UE 102 of FIG. 1 is illustrated with a variety of example devices, including a smartphone 102-1, a tablet 102-2, a laptop 102-3, a desktop computer 102-4, a computing watch 102-5, computing spectacles 102-6, a gaming system 102-7, and a home-automation and control system 102-8. The UE 102 can also include other devices, such as televisions, entertainment systems, audio systems, automobiles, drones, track pads, drawing pads, netbooks, e-readers, home security systems, and other home appliances. Note that the UE 102 can be wearable, non-wearable but mobile, or relatively immobile (e.g., desktops and appliances).

The UE 102 also includes one or more computer processors 108 and one or more computer-readable media 110, which includes memory media and storage media. Applications and/or an operating system (not shown) implemented as computer-readable instructions on the computer-readable media 110 can be executed by the computer processors 108 to provide some or all of the functionalities described herein, such as some or all of the functions of the notification manager 104 and user interface application 106 (shown within the computer-readable media 110, although this is not required, as server or remote techniques may be used in whole or in part).

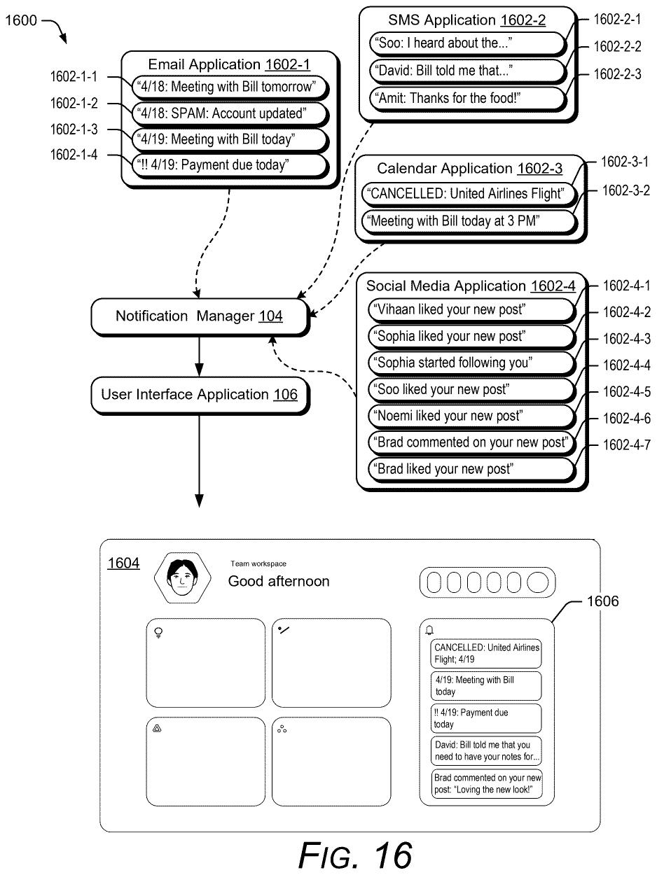

The notification manager 104 receives notifications from the UE 102. These notifications can be received, actively or passively, in groups over a time period or per application, one-at-a-time, and in various manners, such as through push notifications, application program interface (API) notifications, passive notifications, local notifications, and in-app notifications. The notification manager 104 is described in greater detail below and illustrated in part at FIGS. 16-20 and 25.

The UE 102 may also include a network interface 112. The UE 102 can use the network interface 112 for communicating data over wired, wireless, or optical networks. By way of example and not limitation, the network interface 112 may communicate data over a local-area network (LAN), a wireless local-area network (WLAN), a personal-area network (PAN), a wide-area network (WAN), an intranet, the Internet, a peer-to-peer network, a point-to-point network, or a mesh network.

The UE 102 may also include a display 114. The UE 102 can use the display 114 to present the priority group of notifications to the user. The display 114 may be any example display, such as those illustrated in FIG. 1 and showing user interfaces throughout this document.

Regions and functions described herein may be further divided and combined. In this way, different implementations of the UE 102 can be used to implement a user interface for simplified and integrated interaction with multiple applications and/or prioritizing notifications.

### Simplified and Integrated Interactions With Multiple Applications

In more detail, the user interface application 106, shown in FIG. 1, presents, within a user interface, multiple selectable controls with a control region. Each of these controls is associated with a software application, and each can be selected to enable use of functions associated with those software applications. These functions can be reduced-function-set versions of those enabled by a full instance of the software application. Which of the functions are enabled by the user interface application 106, however, can be based on user selection or likely preference for use, determined through a machine-learned model, and in various other manners described herein. In addition to enabling selection and use of reduced-function-set versions of the associated software applications, the user interface application 106 can integrate interactions, such as to alter content of one of the reduced-function-set versions based on an interaction with another of the reduced-function-set versions.

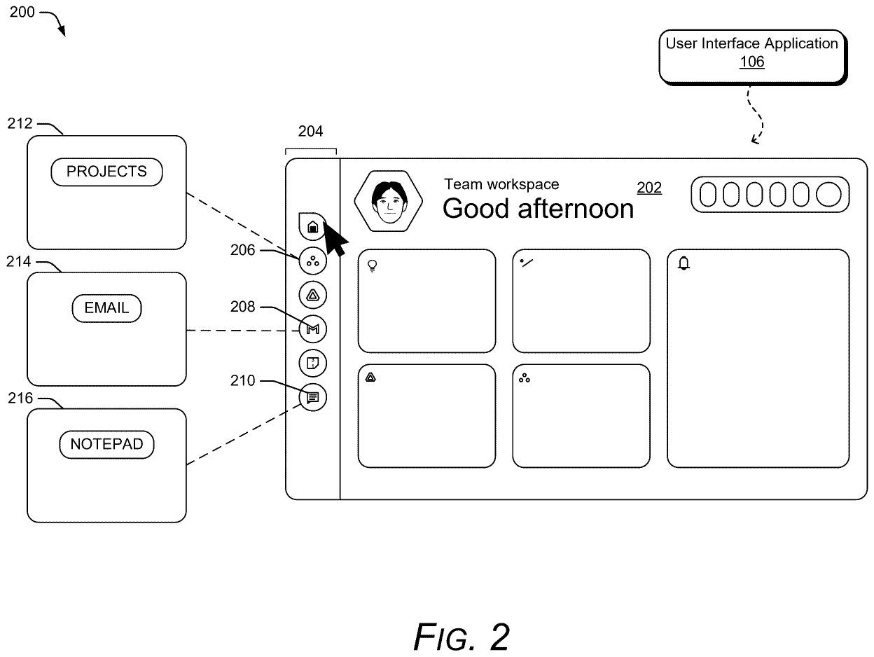

By way of illustration, consider FIG. 2. FIG. 2 illustrates an example environment 200 in which techniques enabling a multi-application user interface for simplified and integrated interaction with multiple applications can be implemented. The environment 200 includes a user interface 202, a control region 204, and first, second, and third selectable controls 206, 208, and 210, which are associated, respectively, with first, second, and third associated software applications 212, 214, and 216, each of which are provided by the user interface application 106. As illustrated, the user interface 202 presents the first, second, and third selectable controls 206, 208, and 210 in the control region 204, although the control region 204 can be oriented horizontally instead. These controls are illustrated with icons associated with the software applications to aid a user's recollection, although this is not required.

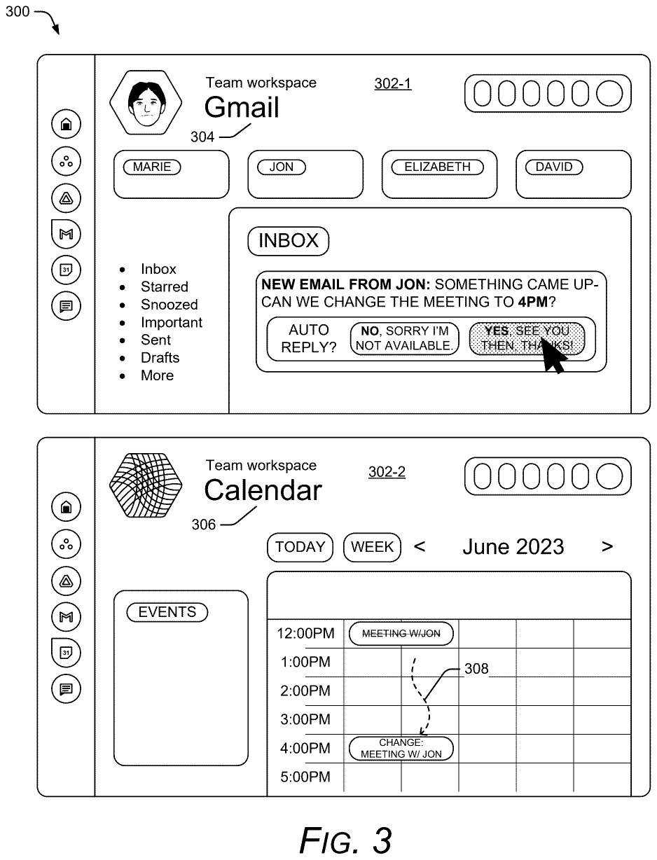

Consider FIG. 3, which shows one example way in which the techniques enable simplified and integrated interaction with multiple applications. Here an example illustration 300 includes a user interface 302 with a first instance 302-1 and a second instance 302-2. In the first instance 302-1 is a first software application 304 (“Gmail”™) and in the second instance 302-2 is a second software application 306 (“Calendar”). The first instance 302-1 of the user interface 302 presents functions associated with the first software application 304 (e.g., “Inbox”). Here a user receives an email from their colleague requesting a change in time for an upcoming meeting. The user has an option to automatically reply to the email, and they select an affirmative response. This response is received by the user interface application 106, shown in FIGS. 1 and 2, and determined to be of relevance to another application associated with the user interface application 106 (e.g., second software application 306). The user interface application 106 then directs the second software application 306 (or causes a reduced function set version of the second software application 306) to reflect the response received through the first instance 302-1. Thus, with a single user selection, here to accept a time change request received through the “Gmail”™ application, the user interface application 106 causes the acceptance to change another application, here to move a prior meeting time with “Jon” from 12:00 pm to an accepted 4:00 pm as requested via email from Jon.

This is but one example of the many ways in which the user interface application 106 enables integrated interaction, here with one interaction through email affecting a calendar application. This effect is illustrated in the second instance 302-2 of the user interface 302 at change 308 (“CHANGE: MEETING W/JON”). This integration of interactions between applications can be based on a prior association between the first software application 304 and the second software application 306, such as through an explicit user selection to associate the first and second software applications 304 and 306 with a substance-based task (e.g., a task that has associated properties), a team of persons (e.g., Jon, the user, and others associated with a task, friendship/work group, or event), or implicit user selections based on a user history of selections and interactions, or through a machine-learned model described elsewhere herein. The prior association may also be based on an implicit user selection to associate the first and second software applications 304 and 306 through a previous physical selection to orient the applications within the user interface 302 (e.g., with a same instance, not shown in FIG. 3) or a different region, which is described in part below.

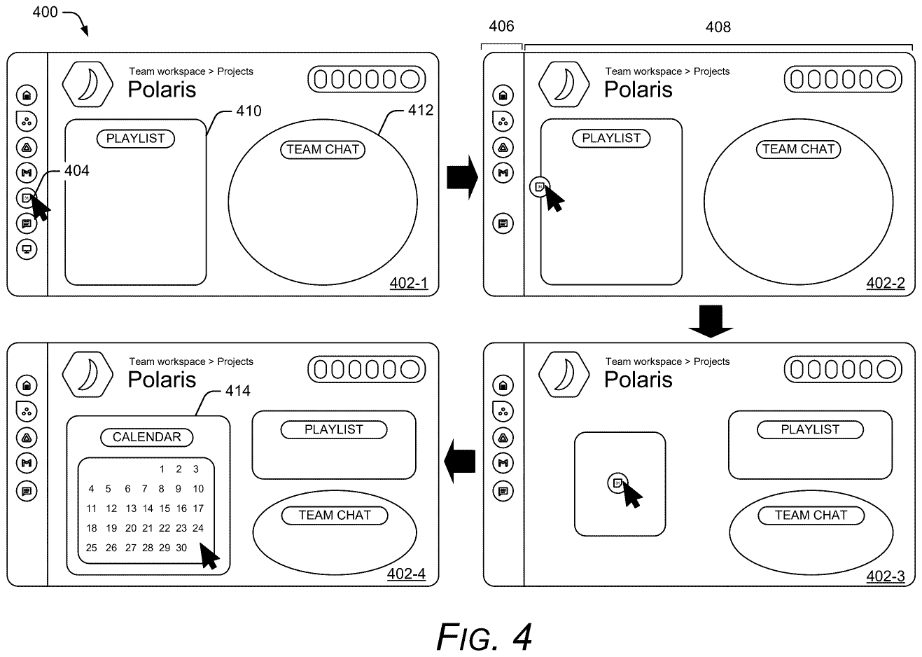

Consider FIG. 4, which illustrates an example environment 400 showing an addition and alteration to a size or orientation of reduced-function-set versions (e.g., application reduced-function-set versions), which, as noted in FIG. 3's description, is one way in which the user interface application 106 may associate software applications. The environment 400 includes a user interface 402 with four instances (first, second, third, and fourth user interfaces 402-1, 402-2, 402-3, and 402-4), a selectable control 404, a control region 406, an application reduced-function-set version region 408 (“app region 408”), and a first, second, and third application reduced-function-set version 410, 412, and 414. The selectable control 404 can be selected, highlighted, or dragged out of the control region 406 (one example of the control region 204 of FIG. 2) into the application reduced-function-set version region 408.

As seen in FIG. 4, the first and second application reduced-function-set versions 410 and 412 are within the app region 408 in the first user interface 402-1. The selectable control 404 is selected and dragged into the app region 408 in the second user interface 402-2. As (or soon thereafter) the selectable control 404 is within the app region 408, the user interface application 106 causes a third application reduced-function-set version 414 to form from the selectable control 404. In the third user interface 402-3, the first application reduced-function-set version 410 and the second application reduced-function-set version 412 are automatically altered to fit by the user interface application 106, which may do so with no user interaction, into the app region 408 along with the addition of the third application reduced-function-set version 414 associated with the selected selectable control 404. Once the selectable control 404 has been unselected, the user interface application 106 causes the third application reduced-function-set version 414 to assume a size or orientation to fit in the application reduced-function-set version region 408. The user interface application 106 adjusts the first application reduced-function-set version 410 and the second application reduced-function-set version 412 without user interaction, as seen in the fourth user interface 402-4.

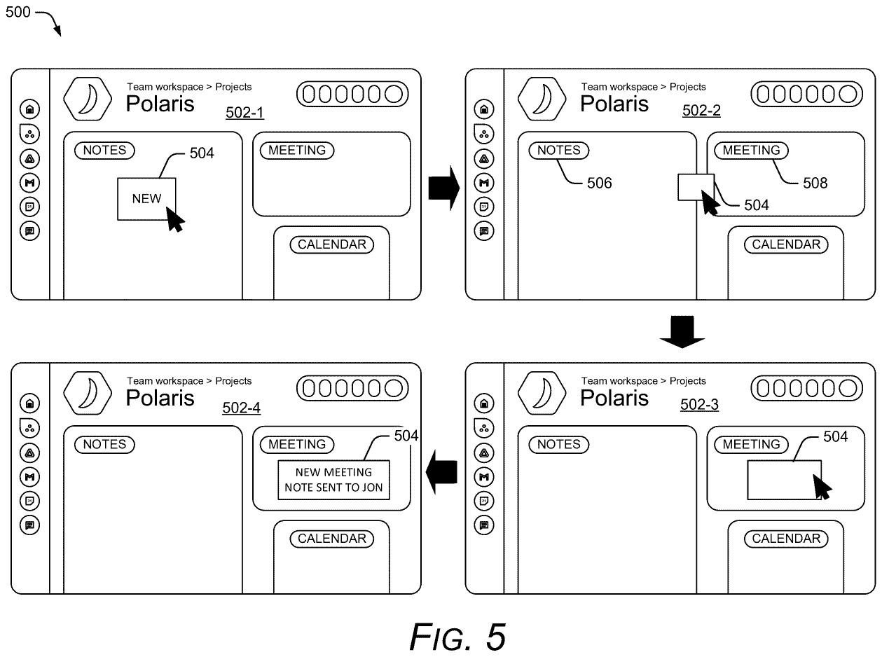

Consider FIG. 5, which illustrates an example environment 500 in which the techniques alter content between software applications. The environment 500 includes a user interface 502 with four instances (user interfaces 502-1, 502-2, 502-3, and 502-4) and a transferrable content 504. In the user interface 502-1, the transferrable content 504 has been selected by a user. In this example, the transferrable content 504 is a new note, but the transferrable content 504 can be a new calendar event, a new document, or another new transferrable item. The user can drag the transferrable content 504 from a first reduced-function set version 506 of a first application to a second reduced-function-set version 508 of a second application, thereby altering content of the second application.

In the user interface 502-2, the user has started to drag the transferrable content 504 from the first reduced-function-set version 506 to the second reduced-function-set version 508. In the user interface 502-3, the user reaches the second reduced-function-set version 508 and drops or releases the transferrable content 504 into the second reduced-function-set version 508. As an example, the transferrable content 504 is a new note that is being taken out of the first reduced-function-set version 506 associated with a note software application and placed into the second reduced-function-set version 508 associated with a team meeting application. This action from the user is received by the user interface application 106, which integrates the interaction between the two applications, here by passing the transferrable content 504 to the second application. The user interface application 106 can identify the task from one application that may be useful in another application through prior user history, through an algorithm, or through machine learning. More specifically, a machine-learned model can be trained through user actions and user history to determine when and where a task is necessary. Once the user interface application 106 has identified a task action to complete, the user interface application 106 can integrate the interaction between the two applications, such as passing the transferrable content 504 from the first reduced-function-set version 506 to the second reduced-function-set version 508.

The communication of information and/or commands and control between applications (e.g., communication of the transferrable content 504 between various reduced-function-set versions or commands by the user interface application 106 to control an SMS software application), can be performed using an inter-process communication (IPC) mechanism. Various processes of IPC mechanisms are contemplated herein, each of which, in whole or in part, can be used for communications between software applications and/or entities controlling or associated with these software applications, such as to pass, receive, and access data and/or control operations and functions of a software application. These IPC mechanisms include, but are not limited to, an application programming interface (API), a remote procedure call (RPC), message queues, shared memory and databases, web services (e.g., simple object access protocol (SOAP) or hypertext transfer protocol (HTTP)), or file-based communication. For example, any or all of these IPC mechanisms may be utilized by the notification manager 104, the user interface application 106, and the various software applications described herein.

As another example, the transferrable content 504 is a newly edited photograph that is being dragged from the first reduced-function-set version 506 associated with a photo editing software application and dropped into the second reduced-function-set version 508 associated with an SMS software application. The user interface application 106 receives this action done by the user and then integrates the interaction between the two different software applications. The transferrable content 504 is passed from the first reduced-function-set version 506 of the first application to the second reduced-function-set version 508 of the second application, thereby allowing the user to communicate their creative photo editing work with others.

As a further example, the transferrable content 504 is a scheduled meeting or event that is taken from the first reduced-function-set version 506 associated with a calendar software application and placed into the second reduced-function-set version 508 associated with a task management software application. The user interface application 106 receives this action from the user and allows the transferrable content 504 to be passed from the first application to the second application by integrating the interaction between the two software applications. The user can now streamline their workflow and manage new events or meetings across two different software applications.

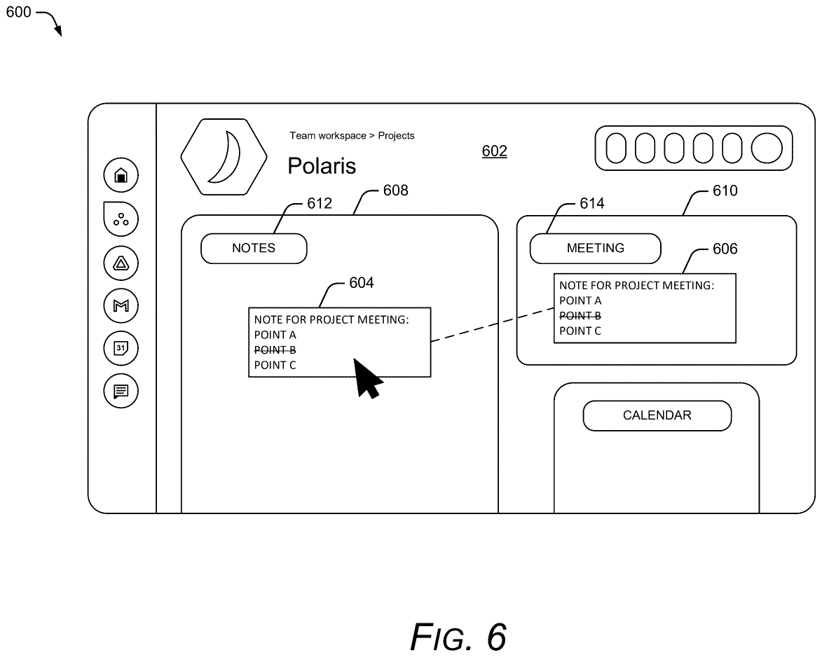

Consider FIG. 6, which illustrates an example environment 600 in which the user interface application 106 alters content that is in two separate but associated applications. The environment 600 includes a user interface 602 and a first and second content 604 and 606. The first content 604 is in a reduced-function-set version 608, which is associated with a first software application 612, and the second content 606 is in a second reduced-function-set version 610, which is associated with a second software application 614. As seen in FIG. 6, the first content 604 has been altered by a user (striking “POINT B”), and since the first and second software applications 612 and 614 are associated with each other, the second content 606 has been altered automatically by the user interface application 106. This can be helpful to a user in many different scenarios; here the user wants to delete a certain aspect of their notes from a meeting. When selected by the user, not only content for a note application will be changed by the user interface application 106, but also content for a team meeting application (e.g., automatically, either with a delay or instantly). The team meeting application receives that alteration from the user interface application 106 so that the rest of a team of the user will see the edit. Likewise, a user may select to change the first content 604 in the reduced-function-set version 608, in which the second content 606 of the second reduced-function-set version 610 will also be added to or changed by the user interface application 106 without need for a user to re-perform the selection or otherwise expend time and effort.

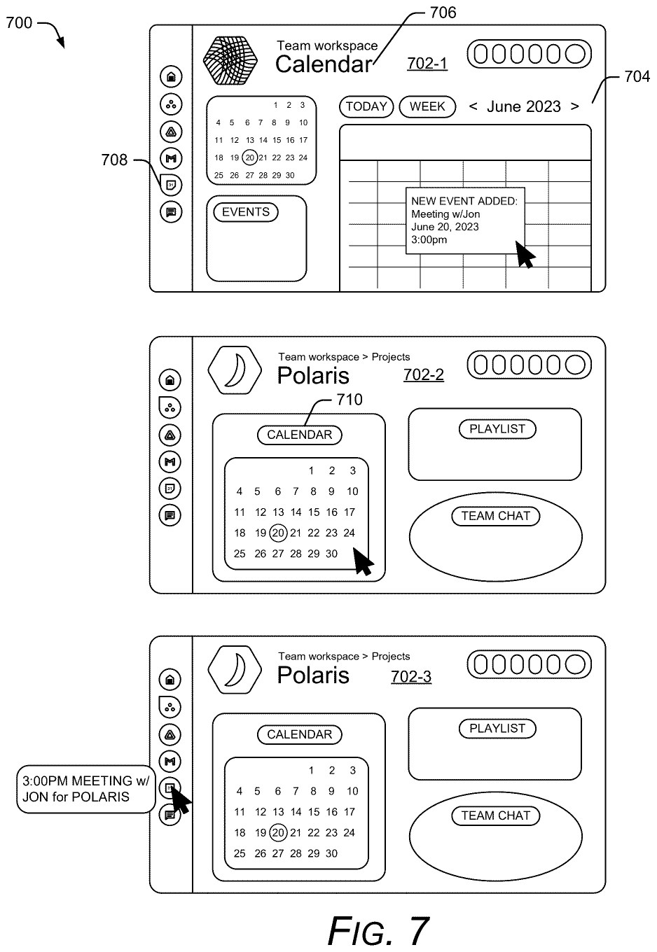

Consider FIG. 7, which illustrates an example environment 700 having a user interface 702, with first, second, and third instances 702-1, 702-2, and 702-3. In the first instance 702-1, the user interface application 106 presents a full-function version 704 of a software application (here a “Calendar” application 706, with an associated selectable control 708). In the full-function version 704, the software application is a full-functioning instance. In the second and third instances 702-2 and 702-3 of the user interface 702, the user interface application 106 presents a reduced-function-set version 710. The reduced-function-set version 710 includes at least one function and at least one information or content that is similar to, or a portion of, the function and information or content as it would be represented in a full-function-set version, respectively. One such example is the full-function version 704 of the software application. In some cases, however, a widget may instead be used. The term widget, as used herein, includes at least information/content associated with the software application or a function. The function for a widget may be different from, the same as, or similar to a function of the software application. The information/content presented by the widget can be similar to or a portion of, or a notification concerning, the information or content. Thus, a widget as used herein can be smaller, lighter, and less content-or function-rich than a reduced-function-set version (e.g., the reduced-function-set version 710). A widget can be a borderless window, an active control (e.g., icon with a single selectable function), a thumbnail (e.g., with information or content that is smaller/reduced or a portion of that which the software application is capable of presenting, such as a small, low-resolution image of a large, high-resolution image), or an applet (e.g., a webpage-based, lightweight user interface module, which, depending on the applet, may also or instead be a reduced-function-set version). In the first instance 702-1, the user interface 106 receives changes from a user and presents a new event (“Meeting w/Jon”) in the full-function version 704 of the “Calendar” application 706. The user interface application 106 also then presents the changes from the user in the reduced-function-set version 710, including in the associated selectable control 708, as seen in the third instance 702-3.

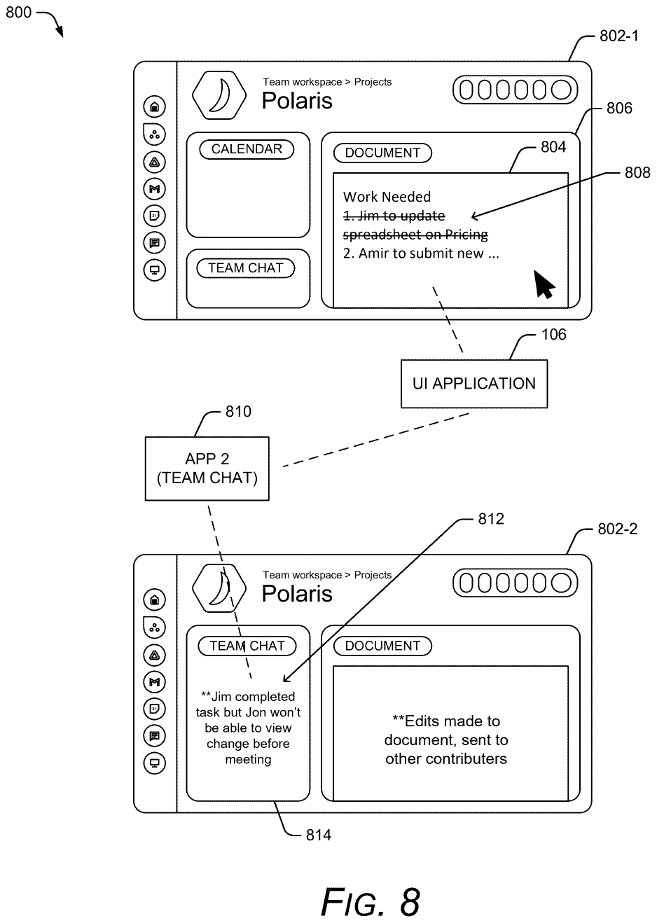

Consider FIG. 8, which illustrates an example environment 800 having a user interface 802, with first and second instances 802-1 and 802-2. The first instance 802-1 illustrates an edit has been made to a document 804 that is displayed within a reduced-function-set version 806 of a word-processing application. Here the document 804 is a task list (“Work Needed”) showing tasks and team members (Jim and Amir) responsible to complete each task. Here team member “Jim” completed task no. 1, the completion of the task being shown with a strikethrough 808 to the task list. This change striking task no. 1 represents one of many examples of a change to content associated with an application, here change to a document of a word processing application. This change is received or determined by the user interface application 106 of FIG. 1. The user interface application 106 determines an association of that document 804 with other applications, such as with a calendar event or a team of persons having a shared SMS group. For the calendar event, the user interface application 106 determines that the document 804 was attached to a meeting invitation. For the team of persons, the user interface application 106 determines that the document 804 has four different persons having editing privileges, including Jim, Amir, Jon, and Susanne, for example. Either or both of these determinations is sufficient for the determination of the association of the document 804 with the other applications. With this determination that the change of content to the document 804 is associated with the calendar event or the group of persons, the user interface application 106 then integrates that change of content from the word-processing application with other applications, thereby integrating a change to one application to another application (e.g., through an IPC mechanism as described above). In this example, the user interface application 106 determines that these same four persons are meeting and that one of those team members (“Jon”) is scheduled to be busy in meetings from the time of the edit being made to the document 804 and the start of that meeting. Based on this, the user interface application 106 may automatically and without user interaction edit the document 804 and/or reattach it to the meeting in the calendar event and/or let the team members know about the change and one team member's absence. Here the user interface application 106 interacts with an SMS application 810 to cause the SMS application 810 to send a team chat 812 indicating the content change and its effect on the team and/or meeting. This SMS indication 812 is shown in a reduced-function-set version 814 of the SMS application 810 within the second instance 802-2.

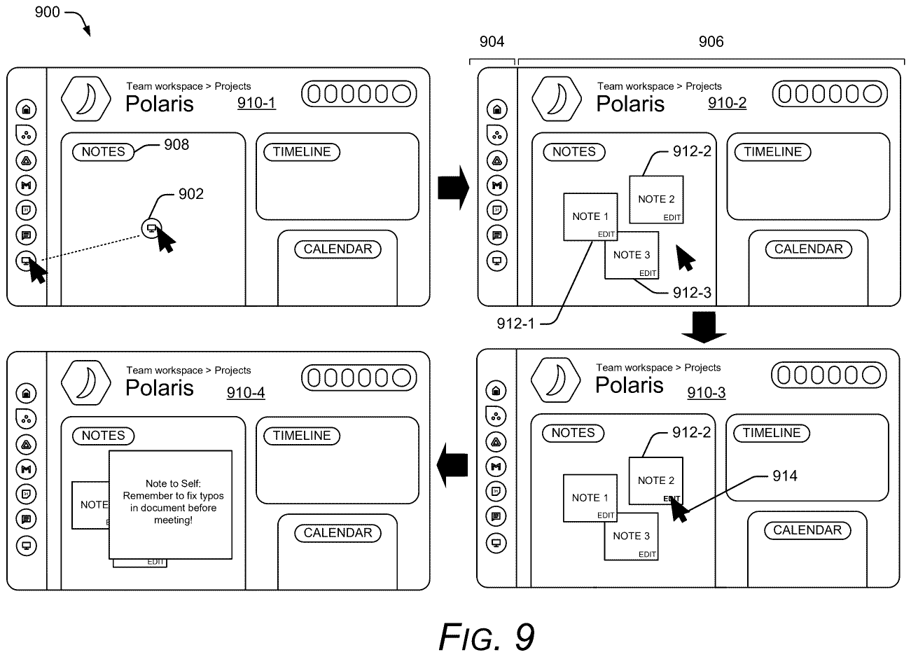

Consider FIG. 9, which illustrates an example environment 900 provided by the user interface application 106 (not shown). The environment 900 includes a first selectable control 902, a control region 904, an application reduced-function-set version region 906, a first software application 908, a user interface 910, with user interface instances 910-1, 910-2, 910-3, and 910-4, and three instances of content 912, shown at content instances 912-1, 912-2, and 912-3. A user may initially select or intermediately select the first selectable control 902 from the control region 904, in which case the user interface application 106 presents one or more instances of content 912 (e.g., a in thumbnail) associated with the first software application 908 onto the application reduced-function-set version region 906 of the user interface 910. The user interface application 106 may also enable selection of various different instances of content 912 by the user, shown with the instances 912-1, 912-2, and 912-3, such as the last three notes viewed, edited, or created by that user. The selection of the second content instance 912-2 is shown within the user interface instance 910-3, at click selection 914. Responsive to the user selecting the instance 910-2 of content 912 (here “Note 2” rather than “Note 1” or “Note 3”), the user interface application 106 presents the full content (to the extent the full content is capable of being presented, which here is the case as the note is fairly short) in the first software application 908 on the user interface 910, as seen in the user interface instance 910-4.

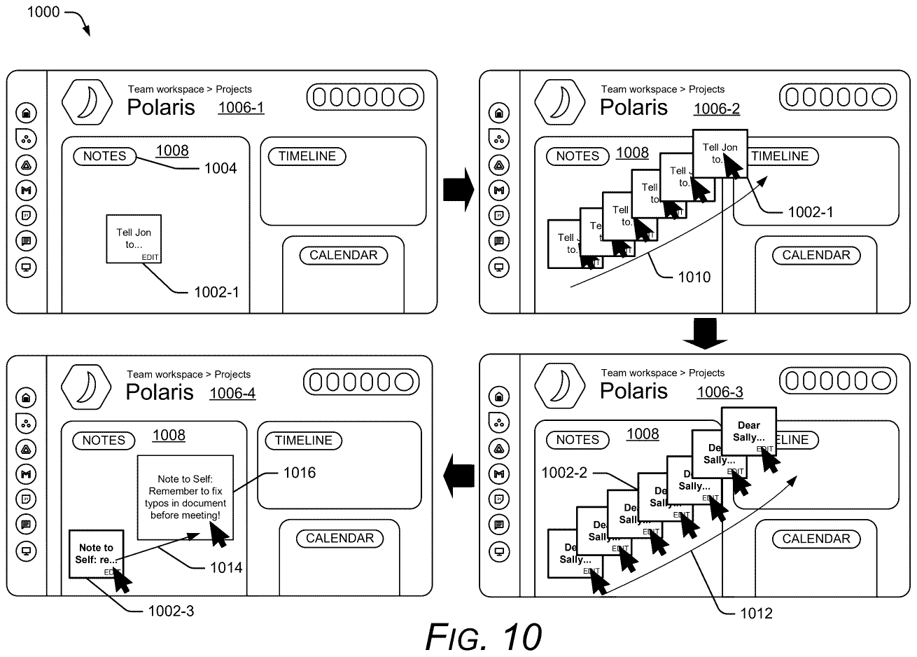

Consider FIG. 10, which illustrates an example environment 1000 in which the user interface application 106 presents reduced-size, reduced-resolution, reduced-function, and/or reduced-content versions of one or more instances of content or functions. The environment 1000 includes content 1002 associated with a software application 1004, here three instances of different content (first, second, and third content instances 1002-1, 1002-2, and 1002-3). As noted, each of these content instances 1002 can be presented in a reduced-size, reduced-resolution, reduced-function, and/or reduced-content version. In this example, the three content instances 1002 are different notes of a notes application, where the displayed size has reduced content due to a size that is not sufficient to include all of the content (e.g., the full text of each note). Other examples are contemplated, however, such as reduced content size (e.g., smaller font or smaller image), reduced resolution (e.g., of an image or text), and reduced functions (e.g., an “Edit” selectable control for the function to edit the content, rather than additional functions, such as font selection, color change, highlighting, and so forth).

The environment 1000 also illustrates a first software application 1004 with which the content 1002 is associated and a user interface 1006 with first, second, third, and fourth user interface instances 1006-1, 1006-2, 1006-3, and 1006-4. As seen in FIG. 10, the user interface application 106 (not shown) presents the content instances and enables selection by a user. These can be presented at once (see FIG. 9) or cycled through one-at-a-time (e.g., moving from the last-edited or viewed to prior, chronologically), and so forth. The cycling through the content instances 1002 is shown in FIG. 10, where the first content instance 1002-1 is presented for selection at a reduced-function-set version 1008 within the first user interface instance 1006-1 and then selected and dragged off the reduced-function-set version 1008 (or to an edge or off the second user interface instance 1006-2), shown with drag selection 1010. After this selection to reject the presented content instance 1002-1, the second content instance 1002-2 is similarly rejected, shown with drag selection 1012 through the third user interface instance 1006-3. Following these, the third content instance 1002-3 is presented, which is then selected and dragged (and dropped), shown at drag-and-drop selection 1014, within or onto the reduced-function-set version 1008 at the fourth user interface instance 1006-4. The user interface application 106 then presents additional content and/or functions, shown with a full-content instance 1016.

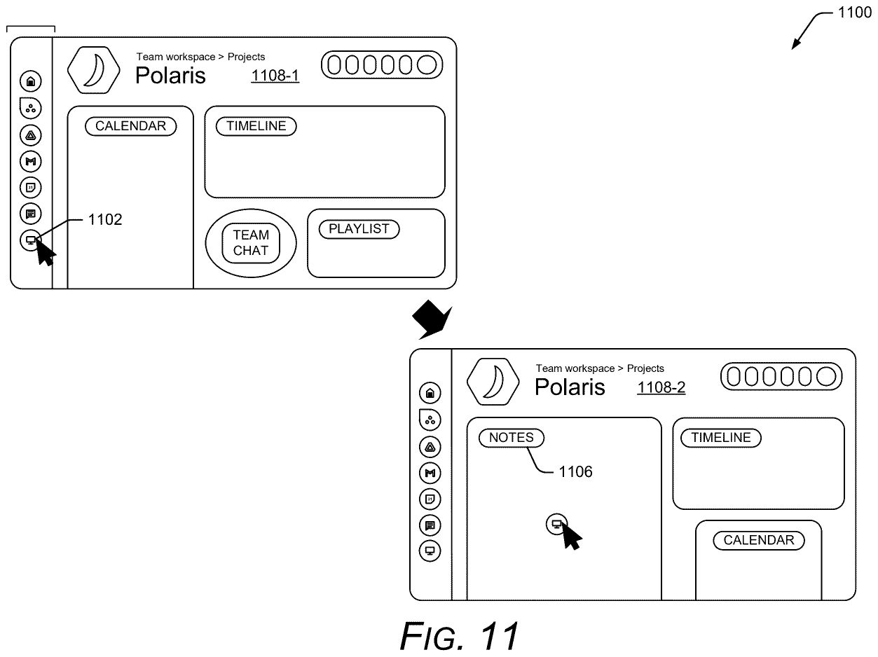

Consider FIG. 11, which illustrates an example environment 1100 of a drag-and-drop of a selectable control. The environment 1100 includes a first selectable control 1102, a control region 1104, a first associated software application 1106, and a user interface 1108, with instances 1108-1 and 1108-2. The user interface application 106 enables selection of the first selectable control 1102, here with a drag-and-drop. The drag-and-drop of the first selectable control 1102 allows for the first selectable control 1102 to be selected by a user while the user interface application 106 still presents the original selectable control 1102 in the control region 1104. As seen in FIG. 11, the first selectable control 1102 can be dragged across the user interface 1108 while still being displayed in the control region 1104. As the first selectable control 1102 is dragged across the user interface 1108, the user interface application 106 presents the first associated software application 1106 on the user interface 1108. When the user drags the first selectable control 1102 across parts of the user interface 1108, the user interface application 106 displays a reduced-function-set version of the first associated software application 1106. For example, as seen in FIG. 11, the user selects a control from the control region 1104 and drags it across the user interface 1108. As the user drags the control across the user interface 1108, reduced-function-set versions for previous software applications shift to match a software application associated with the control that is being dragged. For example, the control that is dragged may be a notes control associated with a notes application, and thus the reduced-function-set versions on the user interface 1108 will change to the notes application when the control is dragged on top of the reduced-function-set versions while other reduced-function-set versions of other applications are displaced, moved, or reduced in size (e.g., removal of an SMS and Playlist, and reducing in size of a Timeline and Calendar).

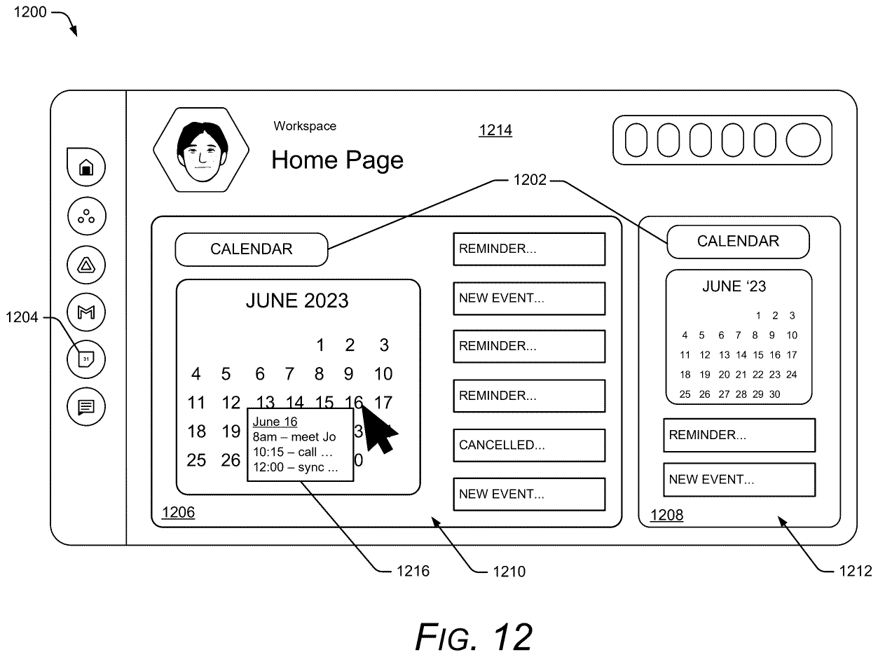

Consider FIG. 12, which illustrates, within an environment 1200, a full-function and a reduced-function version for a same software application, here a calendar application 1202 represented with a selectable control 1204 (here an icon). The environment 1200 includes a first region 1206 and a second region 1208, with a full-function version 1210 within the first region 1206 and a reduced-function-set version 1212 within the second region 1208. A user interface 1214 is provided by the user interface application 106 (not shown).

The first region 1206 is a different size than the second region 1208, and each is located in a different part of the user interface. Within the first region 1206 is the full-function version 1210 of the software application 1202, and within the second region 1208 is the reduced-function-set version 1212 of the software application 1202. These two example options are shown to illustrate but two of various different ranges of functions, sizes, and orientations that the user interface application 106 permits and that a user may select (or be determined by the user interface application 106). As illustrated, the full-function version 1210 includes additional content with four additional notifications, greater size and resolution, and additional functions, such as enabling selection of, and then presenting, a pop-up detail 1216.

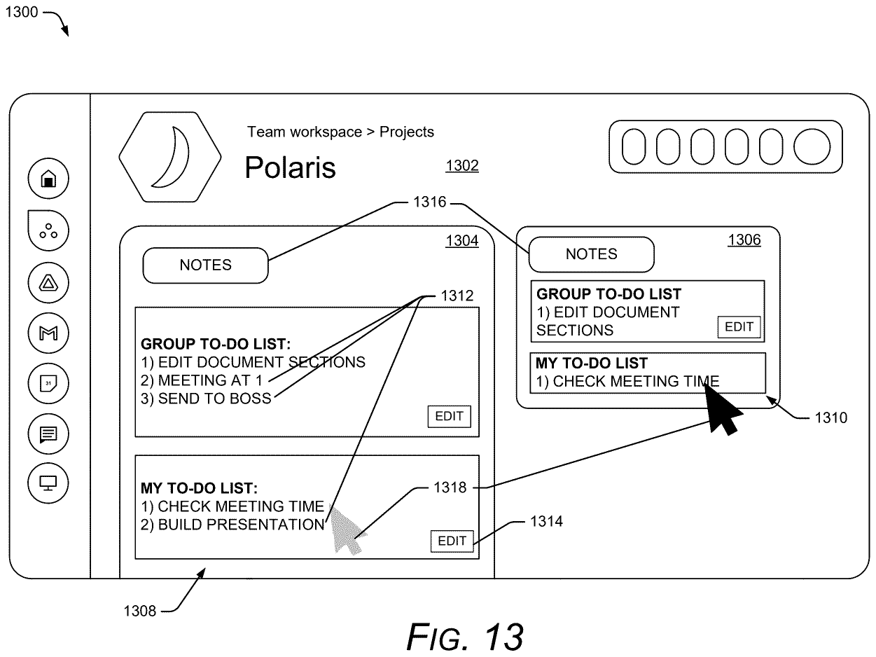

Consider FIG. 13, which illustrates an example environment 1300 having a user interface 1302 showing a first region 1304, a second region 1306, two reduced-function-set versions 1308 and 1310, additional content 1312, and an additional function 1314, all of which are associated with a software application 1316 (“Notes”). Here assume that size and functions are reduced from the reduced-function-set version 1308 to the reduced-function-set version 1310. In so doing, the user interface application 106 may automatically reduce (or increase) content or functions or both. Here, however, assume that a user explicitly selects to reduce content by removing the additional content 1312 and the additional function 1314 (the ability to edit a “my to-do list”). The user selects to maintain two to-do lists, but with space to present only a first item in the list and to remove one editing function and maintain another. This is shown (in part) with a drag-and-drop selection at arrows 1318. While not illustrated, the user is enabled to select just a “group to-do list” or just a “my to-do list”, to remove an edit feature for both, and so forth. The user interface application 106 enables this flexibility, providing these different and customizable reduced-function-set versions 1308 and 1310 through enabling a user to select a size, content, and function of reduced-function-set versions of an application or automatically (e.g., based on user history, machine-learning).

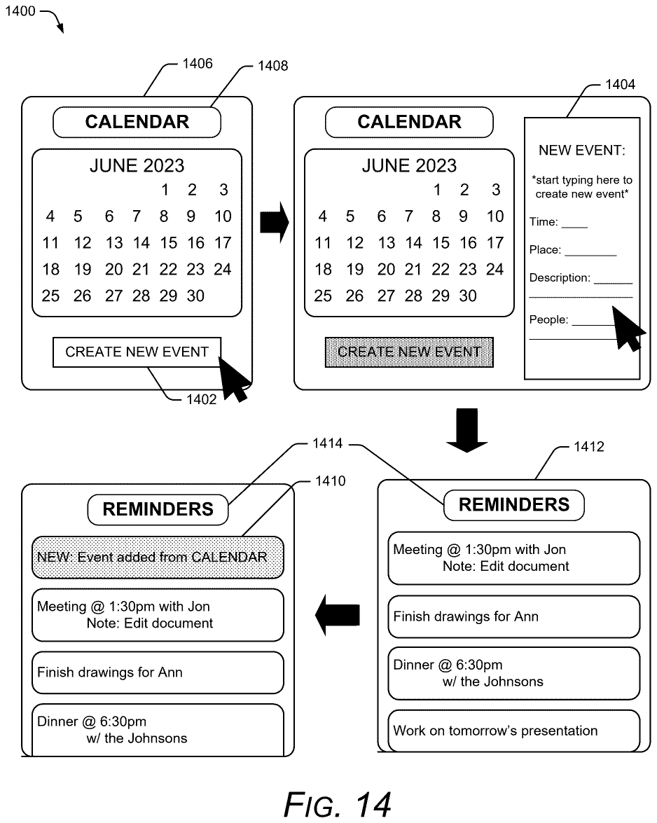

Consider FIG. 14, which illustrates an example environment 1400 having a selectable function of a software application. The environment 1400 includes a selectable function 1402, a first content 1404, a first reduced-function-set version 1406 of a first software application 1408, a second content 1410, and a second reduced-function-set version 1412 of a second software application 1414. The first content 1404 includes information and enables selection of the selectable function 1402 of the first reduced-function-set version 1406 of the first software application 1408. The first content 1404 includes visual information presented to a user within the first reduced-function-set version 1406 of the first software application 1408. The user interface application 106 may enable the user to alter content within the first reduced-function-set version 1406 of the first software application 1408, and, in response, the user interface application 106 alters content of the second reduced-function-set version 1412 of the second software application 1414. This can be done automatically based on an association between the two software applications 1408 and 1414; here, creation of a new calendar event associated with the calendar software application is automatically reflected in a reminder software application. In so doing, the user's interactions are integrated, the user's time is saved, and accuracy and consistency across software applications is improved. The user interface application 106 can cause the content change in one reduced-function-set for one application to be passed to another application after the content is fully changed, or in real time as changes are made. Here selection of the new event associated with the calendar application is made in real time within the reduced-function-set versions 1406 and 1412. Thus, the new event is created and integrated into interfaces for both applications 1408 and 1414 in real time. While not illustrated, as a user types text into the first content 1404, the text can be presented automatically within the second content 1410.

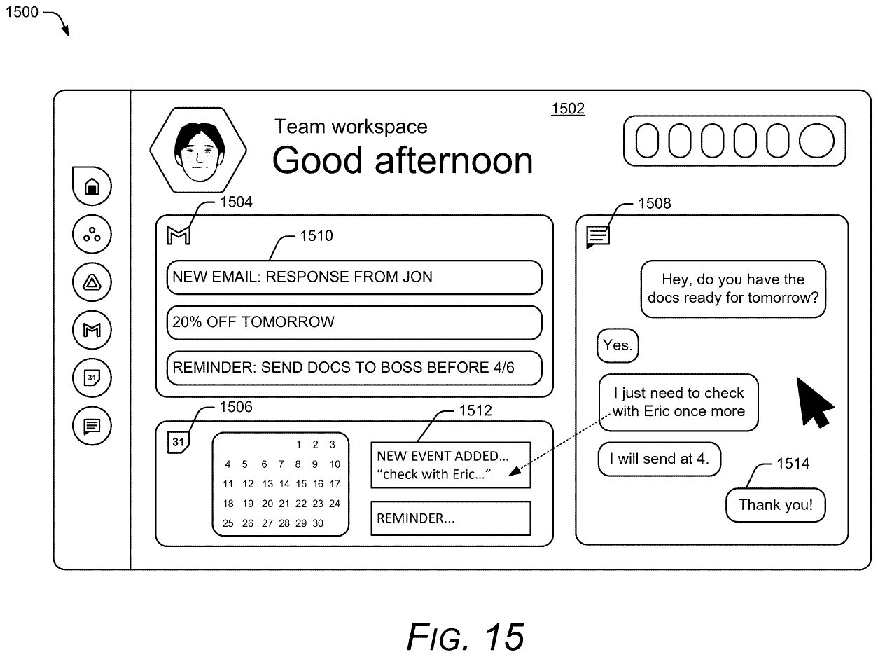

Consider FIG. 15, which illustrates an example environment 1500 showing various content as visual information within a user interface 1502. The user interface application 106 enables selection to alter, whether by changing, adding, or deleting, visual information and to have that information reflected in other regions of the user interface 1502 for other associated software applications. For example, assume that the user interface 1502 includes reduced-function-set versions for an email application 1504, a calendar application 1506, and an SMS application 1508. The visual information includes, respectively, an email 1510, a calendar event 1512, and an SMS message 1514. Each of the visual information forms illustrated, and each of which is a form of content, can be altered through the user interface, and that alteration is made to the associated software application. That alteration may also be reflected within other software applications and the presentation of each within reduced-function-set versions of those software applications. Thus, a text string ending with “Thank you!”, which is made through the user interface 1502, alters the content of the SMS application 1508. Furthermore, that change can also be reflected in associated applications, such as with a reminder created in the calendar application 1506 to remind a recipient of the text string shown to “check with Eric once more” based on analysis of the verb “check” and the first-person usage “I . . . ” . This is but one of many ways in which the techniques and systems described herein enable a user interface for simplified and integrated interaction with multiple applications.

### Notification Manager

FIG. 16 illustrates an example environment 1600 in which techniques enabling a multi-application user interface for prioritizing notifications can be implemented. The environment 1600 includes applications 1602, shown by example as an email application 1602-1, an SMS application 1602-2, a calendar application 1602-3, and a social media application 1602-4; the notification manager 104 of FIG. 1; the user interface application 106 of FIG. 1; and a user interface 1604. The user interface 1604 provides an interface having information and/or functionality associated with more than one application, such as providing notifications from two or more applications and enabling interaction with notifications from two or more applications. The environment 1600 illustrates notifications associated with the applications 1602, here showing the email application 1602-1, the SMS application 1602-2, the calendar application 1602-3, and the social media application 1602-4. The email application 1602-1 has email notifications 1602-1-1, 1602-1-2, 1602-1-3, and 1602-1-4 (e.g., new emails, spam emails, unread emails, urgent emails). The SMS application 1602-2 has SMS notifications 1602-2-1, 1602-2-2, and 1602-2-3 (e.g., text messages, chats, instant messages). The calendar application 1602-3 has calendar notifications 1602-3-1 and 1602-3-2 (e.g., cancelled events, meeting times, event reminders, birthday reminders). The social media application 1602-4 has notifications 1602-4-1, 1602-4-2, 1602-4-3, 1602-4-4, 1602-4-5, 1602-4-6, and 1602-4-7 (e.g., likes, tags, follows, comments).

In the environment 1600, the notification manager 104 receives notifications from at least two of the applications 1602. These notifications can be received, actively or passively, in groups over a time period or per application, one-at-a-time, and in various manners, such as through push notifications, API notifications, passive notifications, local notifications, and in-app notifications (or other IPC mechanism). As illustrated in FIG. 16, the notification manager 104 receives a set of sixteen notifications from the four applications 1602.

The notification manager 104 prioritizes the received notifications into a priority group. The priority group can include two or more of the notifications from the received set of notifications and exclude one or more of the notifications from the set of notifications. The notification manager 104 determines priority, such as an illustrated priority group of five notifications from the set of sixteen notifications in FIG. 16, based on a relation between the notifications, a disparate importance of the notifications, similarity, chronology, a machine-learned model, or prior user selection.

Once prioritized, the notification manager 104, through the user interface application 106, presents the group of prioritized notifications in the user interface 1604, here illustrated at a single region 1606. In more detail and as illustrated in the example environment 1600 of FIG. 16, the notification manager 104 receives the four email notifications 1602-1-1, 1602-1-2, 1602-1-3, and 1602-1-4 from the email application 1602-1, the three SMS notifications 1602-2-1, 1602-2-2, and 1602-2-3 from the SMS application 1602-2, the two calendar notifications 1602-3-1 and 1602-3-2 from the calendar application 1602-3, and the seven notifications 1602-4-1, 1602-4-2, 1602-4-3, 1602-4-4, 1602-4-5, 1602-4-6, and 1602-4-7 from the social media application 1602-4.

Thus, the notification manager 104 receives sixteen different notifications from four of the applications 1602. The notification manager 104 can determine priority based on many factors, such as similar topics or more-recent notifications. For example, the email notification 1602-1-1 and email notification 1602-1-3 have a same subject, but the email notification 1602-1-3 is more recent and describes a meeting occurring that day. Thus, the notification manager 104 prioritizes the email notification 1602-1-3 over the email notification 1602-1-1. The notification manager 104 reads the email notification 1602-1-2 as spam and thus does not prioritize it, but the notification manager 104 marks the email notification 1602-1-4 as urgent and thus prioritizes it and adds it to the priority group. The notification manager 104 receives the SMS notifications 1602-2-1 and 1602-2-3 and determines that they are not related to work and thus does not prioritize them (during the workday). The SMS notification 1602-2-2 includes the name of someone that the user will be meeting with that day; thus, the notification manager 104 prioritizes it, thereby adding it to the priority group to be shown in the user interface 1604. The notification manager 104 prioritizes the calendar notification 1602-3-1 because it is a cancelled event that requires an action on the user's part. The calendar notification 1602-3-2 is determined to have the same content as the email notification 1602-1-3, but the user prefers email notifications over calendar notifications based on user history; thus, the notification manager 104 does not prioritize the calendar notification 1602-3-2. The user has set the user interface 1604 to show comment notifications from the social media application 1602-4 (compared to “likes”); thus, the notification manager 104 prioritizes the social media notification 1602-4-6 over the “like” notifications 1602-4-1, 2, 4, 5, and 7.

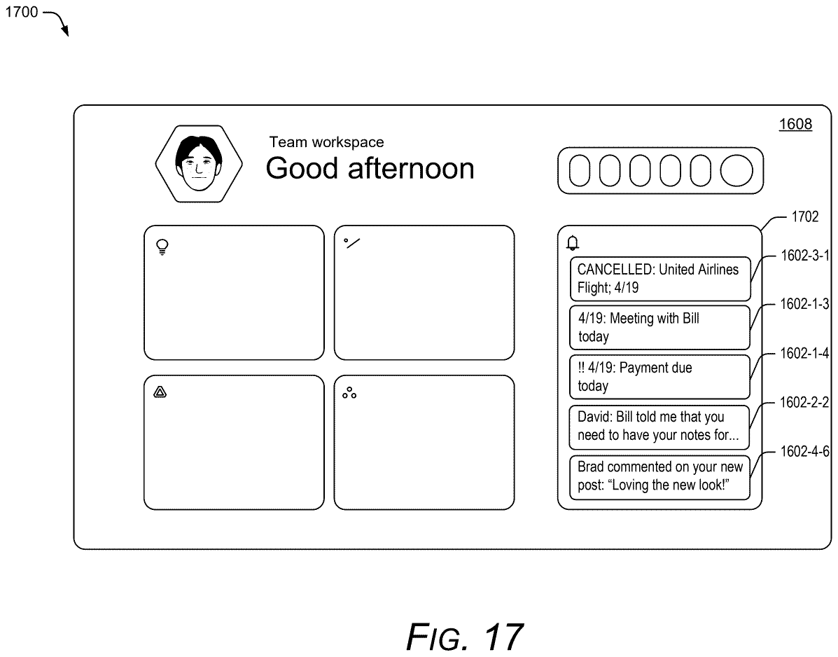

The notification manager 104 may cause the user interface application 106 to present the priority group of notifications in numerous manners, such as in reduced-function-set versions associated with the application from which each notification is received, or in a group that excludes lower-priority notifications, highlights higher-priority notifications but presents many or all of the notifications, or prioritizes the priority group in a list that includes non-priority notifications of the set, such as by listing at a top of a list or using some other visual priority. In the illustrated example, the notification manager 104 directs the user interface application 106 to present the selected notifications for the priority group in the single region 1606 of the user interface 1604, described in more detail in FIG. 17. Instead of requiring the user to sift through the sixteen different notifications across the four different applications 1602, the notification manager 104 presents only five notifications in the single region 1606 of the user interface 1604 that have been prioritized according to the user's needs.

In more detail, consider FIG. 17, which illustrates an example implementation 1700 of the user interface 1604 of FIG. 16. The example implementation 1700 of FIG. 17 includes a priority notification region 1702, the calendar notification 1602-3-1, the email notification 1602-1-3, the email notification 1602-1-4, the SMS notification 1602-2-2, and the social media notification 1602-4-6.

In more detail, the user interface 1604 of FIG. 17 displays the five prioritized notifications that the notification manager 104 received from the applications 1602. In this illustrated example, the priority notifications of the priority group are selected by the notification manager 104 from the 16 notifications received based on an action or response being required (rather than just informational), a chronological importance (e.g., which notifications are about something happening today vs next week), relatedness of notifications (e.g., repetitive or useful/informative), and user history.

A first notification displayed is the calendar notification 1602-3-1, which indicates that the user's flight that day is cancelled. This calendar notification 1602-3-1 is prioritized as the number one notification because it involves something happening today and the notification manager 104 determines that the user will have to make immediate changes to their schedule for that day, thus requiring immediate action from the user (e.g., changing flights, canceling other parts of a trip). A second notification displayed on the user interface 1604 is the email notification 1602-1-3, which tells the user that they have a meeting today, which is chronologically important. These factors in determining priority can be determined by user selection, user history, and/or machine learning. For example, the user may set their preferences of priority to show notifications that will require something (e.g., attending a meeting) from them on that day.

A third notification displayed to the user is the email notification 1602-1-4. The email notification 1602-1-4 has been indicated as urgent, which is used by the notification manager 104 to determine priority, and the notification manager 104 also determines both that the email notification 1602-1-4 is legitimate (not spam, associated with a known or approved email address or company) and that it is chronologically important.

A fourth notification is the SMS notification 1602-2-2, which mentions a certain name relating to the past email notification 1602-1-3. In some instances, the user may want the user interface 1604 to display notifications that immediately relate to a high-priority notification, such as the email notification 1602-1-3; in such a case, the notifications are related or associated in some way. This relatedness can lower a priority or raise it-if the relatedness is repetitive, the priority can be lowered, but in this case, the relatedness is informative or useful for a higher-priority notification, here the past email notification 1602-1-3.

A fifth and final notification in the presented priority group is the social media notification 1602-4-6. This notification tells the user that they have a new comment on their recent social media post. As noted above, the user may explicitly prioritize types of notifications, or the notification manager 104 may determine, through user history and/or a machine-learned model, a priority that a particular user assigns to various types of notifications. Here assume that the user has a habit of selecting to see more information about notifications that are comments on social media (e.g., to read all of the comment itself that is not shown in the priority group presentation or to read through a listing of previous notifications by a user interface of the social media application associated with the comment type of notification).

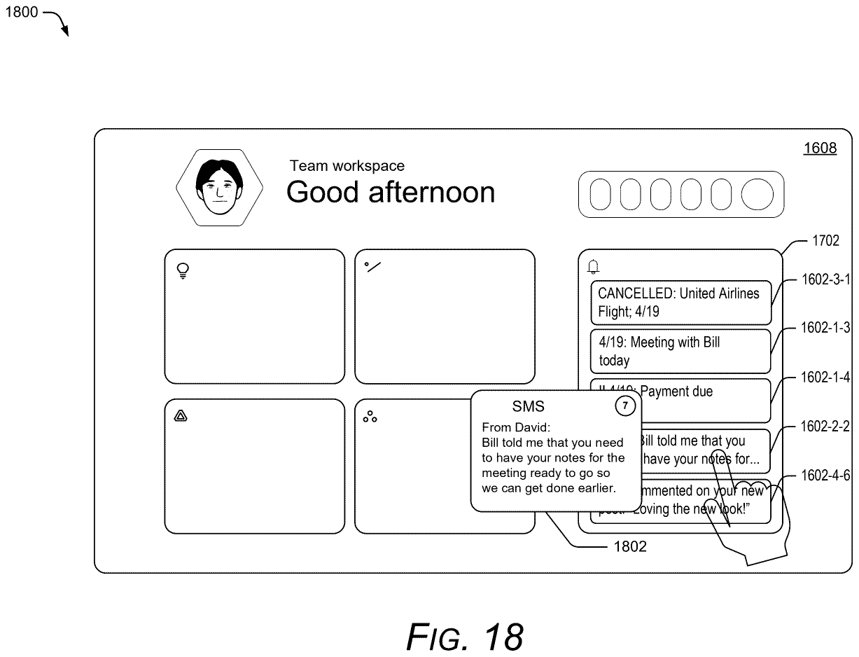

FIG. 18 illustrates an example implementation 1800 of the user interface 1604 of FIG. 16. In the example implementation 1800 of FIG. 18, the user interface application 106 provides a notification pop-up region 1802 responsive to a user selection (taps, hovers over) of a notification displayed in the priority group (e.g., displayed in the priority notification region 1702). The notification pop-up region 1802 here includes the entirety of the notification, although space constraints for long notifications or non-text content may affect an amount of text or content shown. For example, as illustrated in FIG. 18, the SMS notification 1602-2-2 is selected and additional content associated with the notification is presented in the notification pop-up region 1802 to present to the user the full text of the notification. The notification pop-up region 1802 can pop up for any selected notification of the user interface 1604. By enabling this type of expansion within the user interface 1604, the user interface application 106 enables a user to quickly and easily see additional content for a notification. The user does not need to explicitly open the SMS application 1602-2, alter a format of the user interface 1604, or otherwise disturb the user's ease. The user simply taps or hovers over the priority notification, sees additional information associated with the selected notification, and then is able to move on to other tasks. The notification pop-up region 1802 may automatically disappear responsive to a short period of time, responsive to a selection by the user of some other part of the user interface 1604, or simply by the user ceasing to hover over or maintain a tap on the selected notification in the priority notification region 1702.

As another example, the notification pop-up region 1802 may display to the user the total number of notifications from an application associated with the selected notification, here the social media application 1602-4. As seen in FIG. 18, when the SMS notification 1602-2-2 is selected, the notification pop-up region 1802 pops up with the full text of the notification. In a corner of the notification pop-up region 1802, the total number of notifications from the SMS application 1602-2 is displayed to the user. For example, if the user selects the social media notification 1602-4-6 below the SMS notification 1602-2, the notification pop-up region 1802 may display the full text of the notification as well as show that there are seven unread social media notifications.

While illustrated as the notification pop-up region 1802, other forms of an expanded portion of the user interface 1604 may be used, such as making larger the selected notification within the single region 1606 (e.g., the text of the notification pop-up region 1802 being shown entirely within the single region 1606 rather than within a portion of it or over none of it (not shown in FIG. 18)).

While the example user selections include a tap, hover, and tap-and-hold, selection manners can include a mouse, a touchpad, a trackball, a pointing stick, a touchscreen, a graphics tablet, or gesture-based input devices.

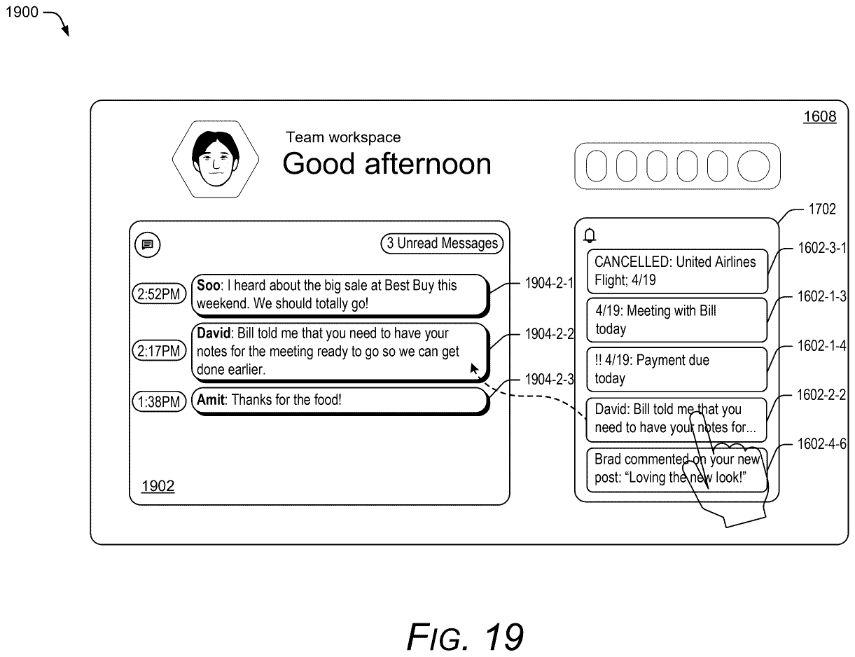

FIG. 19 illustrates an example implementation 1900 of the user interface 1604 of FIG. 16. In the example implementation 1900 of FIG. 19, the user interface application 106 provides an application reduced-function-set version region 1902 responsive to a user selection (e.g., taps, hovers over) of a notification displayed in the priority group (e.g., displayed in the priority notification region 1702). The user interface application 106 may open (“launch”) an application associated with the selected notification, provide separate but similar functionality to the application without launching the application, or communicate with the application (assuming it is already launched) to provide functionality for the reduced-function-set version.

The example implementation 1900 illustrates the application reduced-function-set version region 1902 within the user interface 1604. The notifications within the user interface 1604 can be selected, moved, or pushed to enable one of the applications 1602 to open into the application reduced-function-set version region 1902 presented to a user on the user interface 1604. For example, the user may select a notification (e.g., SMS notification 1602-2-2), which in turn opens the application reduced-function-set version region 1902, which is then directed to present all notifications (unread, or read and unread, etc.) from that specific application. For example, the techniques here direct the application reduced-function-set version region 1902 to present three unread SMS notifications, such as the SMS notifications 1602-2-1, 1602-2-2, and 1602-2-3 of FIG. 16, in order of newest to oldest, but with additional or all of the content of each notification, shown at full-content notifications 1904-2-1, 1904-2-2, and 1904-2-3 (respectively). While illustrated with the unread messages and full content, the application reduced-function-set version region 1902 can be used to display the full content of the selected notification (or as much as is practicable) or used in other manners. Note also that in this example the application reduced-function-set version region 1902 replaces four other reduced-function-set versions shown in FIG. 16. The user interface application 106 may do so or forgo doing so based on various factors, such as a size of the application reduced-function-set version region 1902 needed to display associated notifications or a single full or near-full content notification, user history or selection for how they desire their user interface 1604 to behave, or an existence of a reduced-function-set version for the application associated with the selected notification already being in the user interface 1604. Thus, if one of the four reduced-function-set versions in FIG. 16 is associated with the application from which the selected notification was received, the full or larger content of the selected notification may simply be presented on the existing reduced-function-set version. Furthermore, the user interface 1604 may highlight the application reduced-function-set version region 1902 responsive to a selection or partial selection of a notification within the priority notification region 1702. By so doing, the user may quickly understand where more information about the notification will be presented if the selection is completed (e.g., from a hover over to a tap).

In other aspects, the user interface application 106 enables the user to interact with notifications presented within the application reduced-function-set version region 1902, which may include actions such as marking them as read or unread, deleting them, or replying to them, even in cases where the application is not launched for the associated notification. The application reduced-function-set version region 1902 may also display associated metadata or other information, such as sender information, date and time of receipt, and associated attachments or links. The user interface application 106 may also facilitate the user's ability to switch between various applications and their associated notifications, which may be accomplished through use of tabs or a drop-down menu, for example. In these various examples for the user interface 1604, the techniques enable the user to easily and simply move through notifications based on their priority, applications associated with those notifications, and even lower-priority notifications.

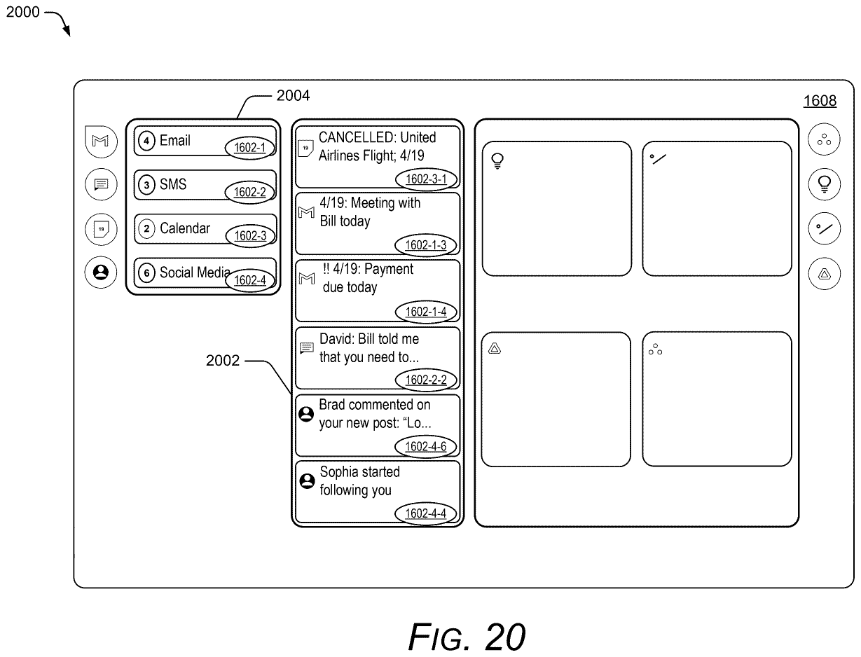

FIG. 20 illustrates another example implementation 2000 of the user interface 1604 from FIG. 16 with different regions and their arrangements. The system 2000 includes a priority notification region 2002 in which prioritized notifications from the four software applications 1602 of FIG. 16 are located. Note that this priority notification region 2002 is larger than the priority notification region 1702 of FIG. 17, showing a priority group of six notifications. The user interface 1604 can be altered by user selection or based on a user's history or a machine-learned model. For the example implementation 2000, the techniques add additional emphasis and space for notifications over those shown in FIG. 16, here shown with the priority notification region 2002 being larger and centered. Further, the example implementation 2000 includes a notification summary region 2004, which presents names for applications from which notifications are received, here the “email” application 1602-1, the SMS application 1602-2, the calendar application 1602-3, and the social media application 1602-4. This notification summary region 2004 also includes information about the set of notifications received and/or received and unread, here 15 of the prior 16 notifications, indicating that one of the notifications has been read and/or deleted. An additional priority notification of the priority group is shown at the social media notification 1602-4-4, which indicates that a person named “Sophia” has started following the user.

As shown in FIGS. 16-20, many types and arrangements of user interfaces are enabled by the techniques, including larger or smaller notification regions, reduced-function-set versions, pop-up regions, and so forth, which are adjustable both by a user and through analysis of the user or other users' behavior. Through these user interfaces, however, a user is enabled to save time and add convenience to notification management.

### Inter-Process Communication

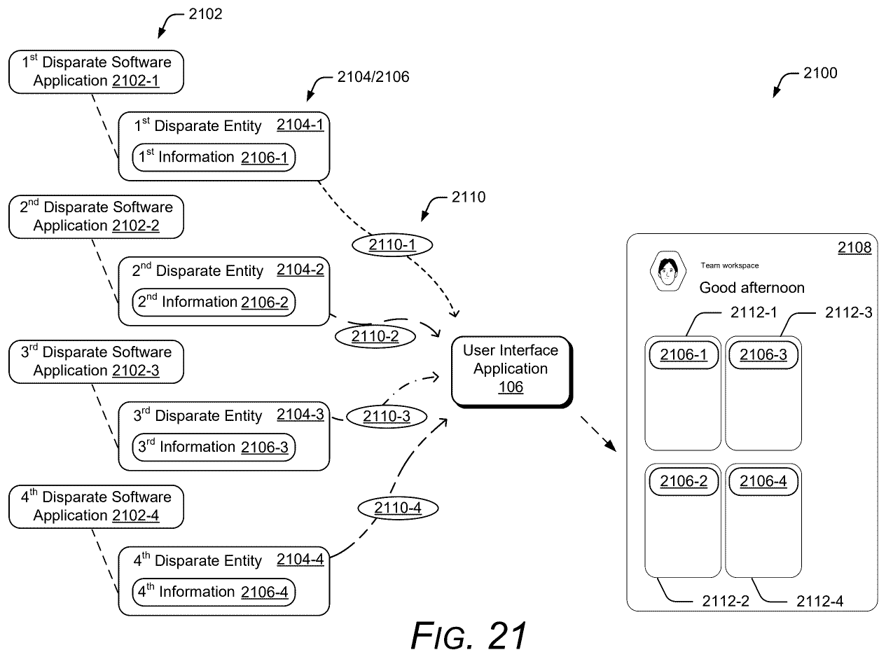

FIG. 21 illustrates an example environment 2100 in which techniques enabling a user interface integrating disparate software applications through inter-process communication mechanisms can be implemented. The environment 2100 includes disparate software applications 2102, disparate entities 2104, information 2106, and an example user interface 2108. These are shown by example, with a first disparate software application 2102-1, a second disparate software application 2102-2, a third disparate software application 2102-3, and a fourth disparate software application 2102-4; the disparate entities 2104, shown by example as a first disparate entity 2104-1, a second disparate entity 2104-2, a third disparate entity 2104-3, and a fourth disparate entity 2104-4; and the information 2106, shown by example as a first information 2106-1, a second information 2106-2, a third information 2106-3, and a fourth information 2106-4.

The user interface application 106 receives information 2106 from the disparate entities 2104 through inter-process communication mechanisms (directly or through the disparate software applications 2102 with which each is associated), which can be identical or differ for each respective information received. For example, consider inter-process communications (IPCs) 2110, shown by example with four different IPCs 2110-1, 2110-2, 2110-3, and 2110-4. As noted in part above, these various IPCs 2110 can include an application programming interface (API), a remote procedure call (RPC), message queues, shared memory and databases, web services (e.g., simple object access protocol (SOAP) or hypertext transfer protocol (HTTP)), or file-based communication, to name just a few.

In response to receiving the information 2106, the user interface application 106 presents, in the user interface 2108, one or more of the instances of the information 2106 with associated widgets 2112. For example, the user interface application 106 presents a first portion of the first information 2106-1 within a first widget 2112-1, a second portion of the second information 2106-2 within a second widget 2112-2, a third portion of the third information 2106-3 within a third widget 2112-3, and a fourth portion of the fourth information 2106-4 within a fourth widget 2112-4. These widgets 2112 may be reduced-function-set versions of full-function-set versions associated with full instances of software applications, respectively. The user interface application 106 may do so with a portion or part of the information 2106 presented and concurrently or serially (e.g., presenting the first and second information 2106-1 and 2106-2 at a same time or one-at-a-time). The user interface application 106 may present the information 2106 in various manners and orientations, such as manners illustrated in FIGS. 4 and 7-20.

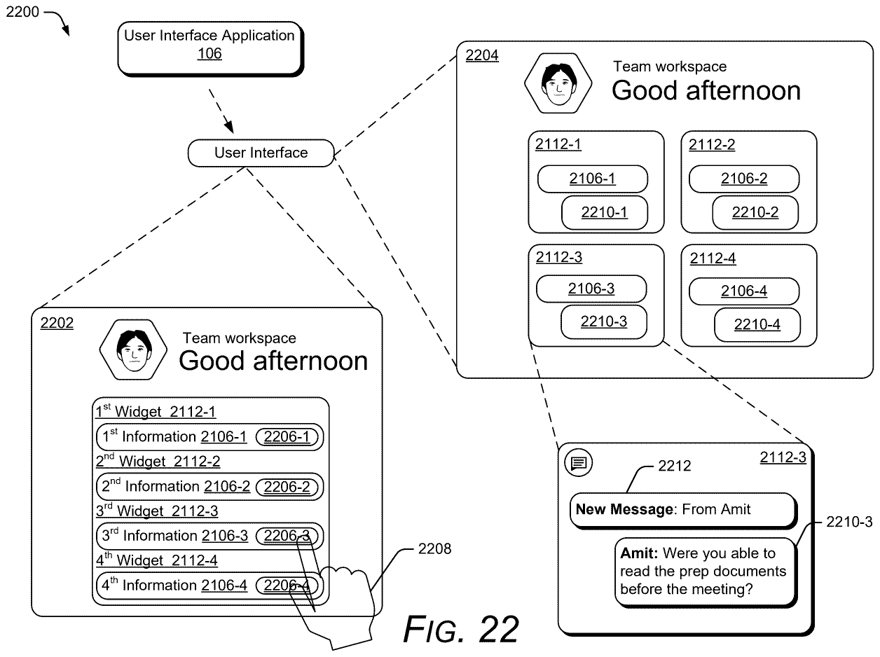

In two examples, consider FIG. 22, which illustrates an environment 2200 having example first and second user interface instances 2202 and 2204, respectively. The first user interface instance 2202 shows a list-oriented presentation of widgets 2112 and their associated information 2106. The second user interface instance 2204 shows a tile-oriented presentation of widgets 2112 and their associated information 2106.

In these example orientations, and those of the other illustrated figures described herein, the user interface application 106 enables selection of the respective information 2106. This selection can be in various manners, such as hot key, mouse click, audio, and touch through a touch-enabled display. Here the example illustrates selection through touch selection.

The environment 2200 includes selectable controls 2206, a touch selection 2208, additional information 2210, associated instances of information 2106, and associated widgets 2112. These are shown by example, with a first selectable control 2206-1, a second selectable control 2206-2, a third selectable control 2206-3, and a fourth selectable control 2206-4; the additional information 2210 is shown by example as a first additional information 2210-1, a second additional information 2210-2, a third additional information 2210-3, and a fourth additional information 2210-4. The user interface application 106 enables selection of or associated with at least the first portion of the first information 2106-1 through the first selectable control 2206-1 associated with the first widget 2112-1 within the user interface instance 2202. As seen in FIG. 22, each respective information 2106 has its own selectable control 2206 in the same location within each associated widget 2112 (though this is not required). The widgets 2112 can be of various types described or illustrated herein, such as the first widget 2112-1 being a borderless window, active control, or thumbnail (e.g., as described and illustrated in FIG. 10).

In response to receiving the selection of the first selectable control 2206-1, the user interface application 106 provides the first additional information 2210-1 (or an additional function) associated with the first information 2106-1 within the user interface instance 2204.

For example, the third information 2106-3 may be a notification for a new message and the associated widget 2112-3 may be an SMS application window. Thus, in response to the user selecting, at 2208, the third selectable control 2206-3, the user interface application 106 provides the third additional information 2210-3, which may be the entirety of the new message. The third information 2106-3 includes “New Message: From Amit, Amit: Were you able to read the prep documents before the meeting?”. A portion 2212 of the third information 2106-3 is shown: “New Message: From Amit”. The additional information 2210-3 includes “Amit: Were you able to read the prep documents before the meeting?” This additional information 2210-3 is presented by the user interface 106 responsive to the selection by the user.

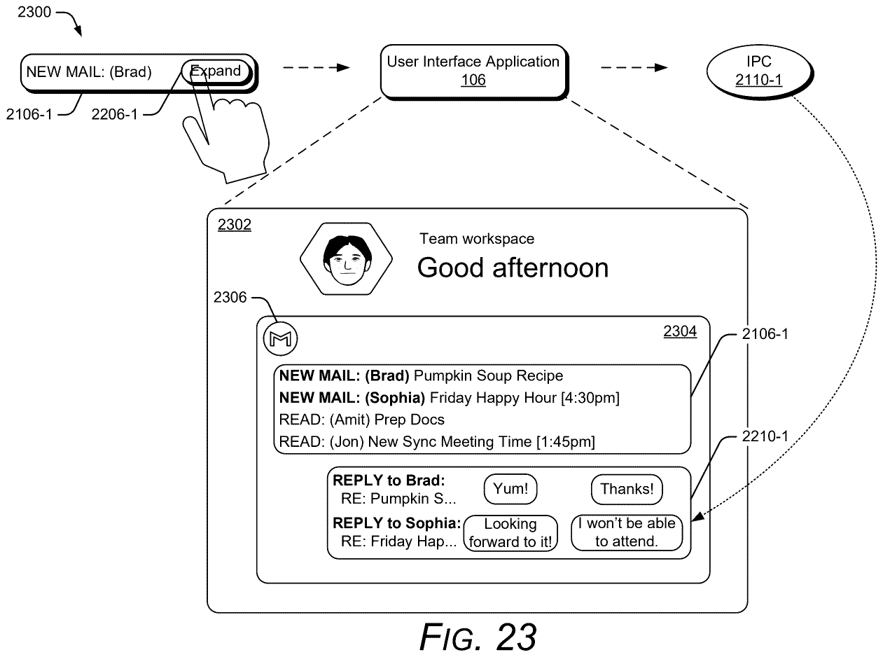

FIG. 23 illustrates an example environment 2300 in which techniques causing presentation of a full instance of an interface for a software application can be implemented. Causing the presentation can be performed automatically and without further user interaction effective to present additional information or performance of a selected function associated with the information. This is illustrated in the environment 2300 though a user interface 2302, a first full instance 2304 of a first software application 2306, the first information 2106-1, the first selectable control 2206-1, the first additional information 2210-1, the first IPC mechanism 2110-1, and the user interface application 106.

Here, in response to receiving selection of the first selectable control 2206-1, the user interface application 106 causes presentation of the first full instance 2304 of the first software application 2306 onto the user interface 2302. The user interface application 106 also causes the first additional information 2210-1 to be automatically presented onto the user interface 2302, through the first IPC mechanism 2110-1, with no further user interaction once the first full instance 2304 has been presented.

For example, the user interface application 106 may present the first full instance 2304 of an email software application (e.g., the first software application 2306) onto the user interface 2302. Within the first full instance 2304, the user interface application 106 may present, through the first IPC mechanism 2110-1, a notification center with new and read emails (e.g., the first information 2106-1) and additional functions where the user can choose to reply to the new emails automatically (e.g., the first additional information 2210-1).

In various implementations, the user interface application 106 and/or the notification manager 104 perform operations based on a machine-learned model. Many example usages are described herein, such as using a machine-learned model to integrate content changes through multiple associated software applications and/or prioritizing a set of notifications into a priority group. This machine-learned model can be determined based on a history of prior user behavior, such as by a user of the user interface 1604 and/or other users. The history of prior user behavior can be determined through user selection history (local or remote, one user or many). For example, the history of prior user behavior can be used to train the machine-learned model. The history of prior user behavior can include multiple users not associated with the user of the user interface. The history of prior user behavior also includes selection history indicating selections through other priority groups of other user interfaces associated with the user interface application.

### Machine-Learned Models, Training, and Techniques

In various implementations, the user interface application 106 and/or the notification manager 104 perform operations based on a machine-learned model. Many example usages are described herein, such as using a machine-learned model to integrate content changes through multiple associated software applications and/or prioritizing a set of notifications into a priority group. This machine-learned model can be determined based on a history of prior user behavior, such as by a user of the user interface 1604 and/or other users. The history of prior user behavior can be determined through user selection history (local or remote, one user or many). For example, the history of prior user behavior can be used to train the machine-learned model. The history of prior user behavior can include multiple users not associated with the user of the user interface. The history of prior user behavior also includes selection history indicating selections through other priority groups of other user interfaces associated with the user interface application.

For the purposes of this disclosure, a machine-learned model is any model that accepts an input, analyzes and/or processes the input based on an algorithm derived via machine-learning training, and provides an output. The model input (the set of notifications) can be analyzed or processed by the model to generate the model output (e.g., the prioritized group of notifications, the content passed from one software application's interface to another).

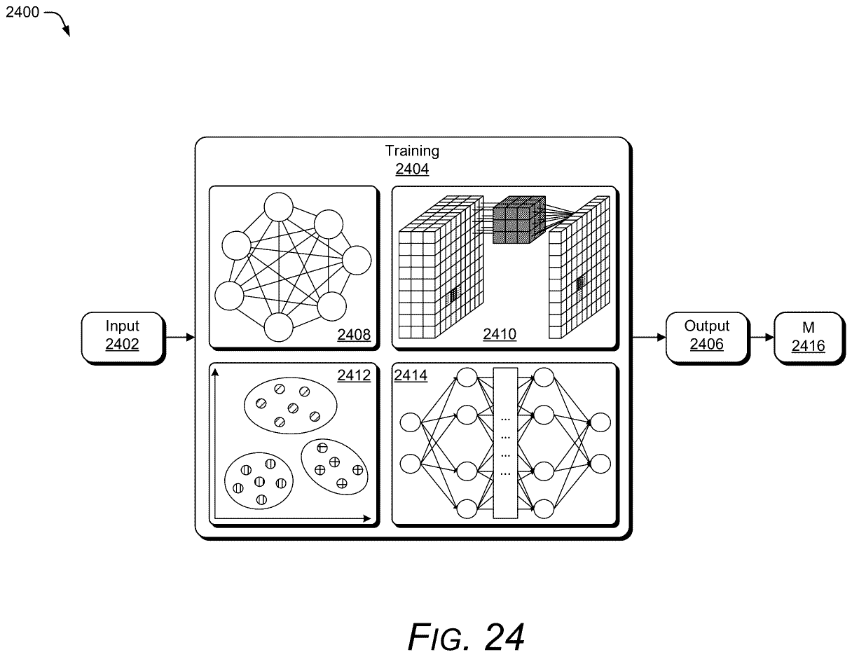

FIG. 24 represents an example machine-learning block diagram 2400. An input 2402 is fed into a training module 2404, which processes the input 2402. The training module 2404 provides a prediction output 2406. The prediction output 2406 can represent a known correlation with the input 2402, such as, for example, prioritized notifications from a set of notifications. Machine-learning may be used for integrating content changes. For example, a user may receive an email notification containing an event invitation, in which a machine-learned model may identify relevant details of the event to then create a corresponding calendar entry automatically without requiring the user to manually add a calendar entry. The training module 2404 can include several specified ways of processing the input 2402 and generating the output 2406, including, but not limited to, a multilayer perceptron neural network (MLP) 2408, convolutional neural networks (CNN) 2410, k-means clustering 2412, a Boltzmann machine 2414, and others not illustrated, such as recurrent neural networks (RNN). The input 2402, the training module 2404, and the output 2406 can be used to generate a machine-learned model M 2416.

In some examples, the input 2402 can be training input labeled with known output correlation values, and these known values can be used to optimize the output 2406 in training using an optimization/loss function.

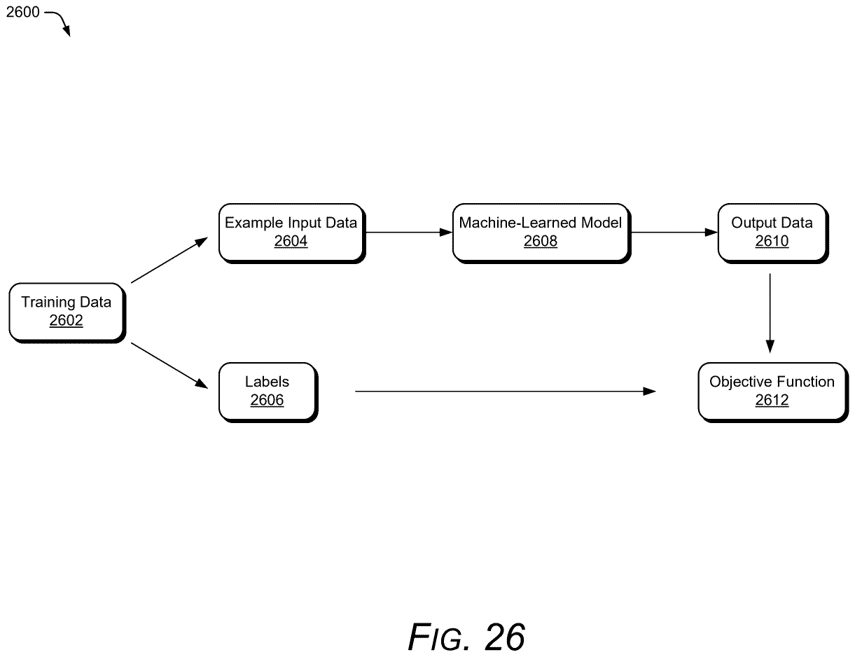

The machine-learning method disclosed involves collecting data about a user's history from various sources, including but not limited to user interactions with websites, mobile apps, and social media activities. Relevant features are then extracted from the collected data (e.g., for CNN), which involves selecting the most significant information that will be used to make predictions. For instance, features such as the user's interaction history with notifications, their location, and a time of day they are most active may be relevant. As an example, a user may receive an SMS message asking for assistance with a task from a colleague. Based on relevant features such as the user's priority levels for tasks, which contacts they prioritize, and which task categories they tend to engage with, the model may then create a task in a task management application corresponding with details from the SMS message. After extracting the features, an appropriate machine-learning algorithm is selected based on characteristics of the data and the type of problem being solved. A supervised learning algorithm may be utilized, where the model (e.g., machine-learned model 2608) is trained on labeled data (e.g., labels 2606 of FIG. 26). During training, the algorithm adjusts its internal parameters to minimize a difference between its predictions and actual importance levels of notifications in the training data. Once the model has been trained, it can be deployed to predict the importance of new notifications based on the user's history. These predictions can then be utilized to deliver crucial notifications to the user in a timely and relevant manner. For example, a user may have a social media application that shares notifications about likes, comments, and new posts. Based on the training on labeled data, the model knows that this user frequently engages with posts relating to a specific topic or from certain friends or content creators. Using this information, the model can send notifications that are most important to promptly update the user about posts from their friends or favorite sports player, for example. This ensures that the user stays connected to a social media network but is not overwhelmed with meaningless notifications that do not interest them.

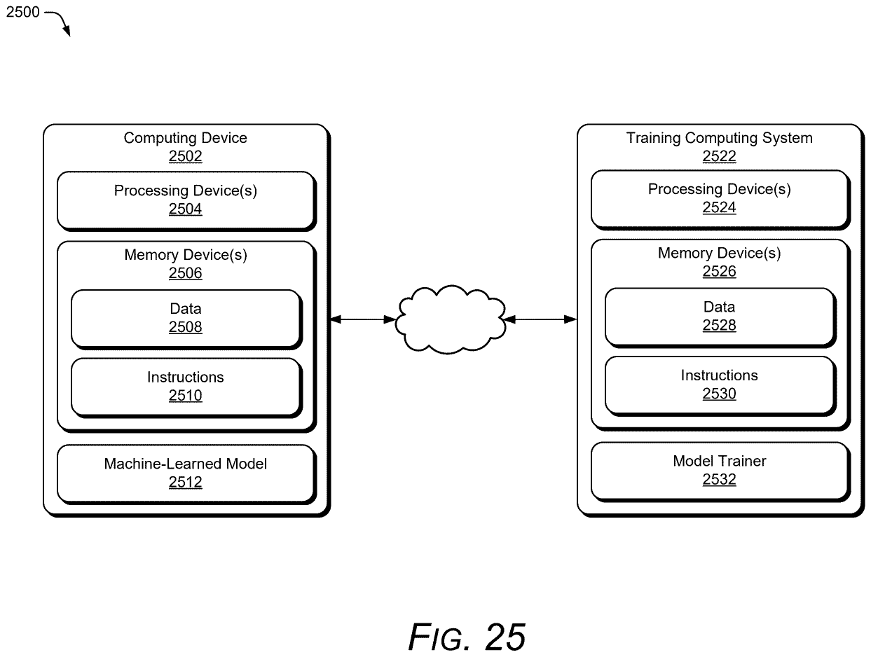

In some implementations, the machine-learned models described herein can be trained at a training computing system and then provided for storage and/or implementation at one or more computing devices, as described above. For example, a model trainer can be located at the training computing system. The training computing system can be included in or separate from the one or more computing devices that implement the machine-learned model. As one example, FIG. 25 illustrates a block diagram 2500 of an example computing device 2502 having one or more processing devices 2504, memory devices 2506 having data 2508 and instructions 2510, and a machine-learned model 2512 in communication with an example training computing system 2522 having one or more processing devices 2524, memory devices 2526 having data 2528 and instructions 2530, and a model trainer 2532.

In some implementations, the machine-learned model 2512 can be trained in an offline fashion or an online fashion. In offline training (also known as batch learning), a model is trained on the entirety of a static set of training data. In online learning, the model is continuously trained (or re-trained) as new training data becomes available (e.g., while the model is used to perform inference).

The model trainer 2532 can perform centralized training of the machine-learned models 2512 (e.g., based on a centrally stored dataset) or decentralized training (e.g., distributed training or federated learning) to train, update, or personalize the machine-learned models 2512.

The machine-learned models described herein can be trained according to one or more of various different training types or techniques. For example, the machine-learned models can be trained using supervised learning in which the machine-learned models are trained on a training dataset that includes instances or examples that have labels. The labels can be manually applied by experts, generated through crowdsourcing, or provided by other techniques (e.g., by physics-based or complex mathematical models). In some implementations, if a user has provided consent (e.g., for their selection history of notifications), the training examples can be provided by the user computing device 2502. For example, a user may select a note in a notes application and associate it with another selected document in a word-processing application. Using supervised learning to train the model based on examples such as the one above, the machine-learned model may then learn to recognize patterns and correlations between certain notes and documents, such as a common project or a particular meeting. When the user selects a note, the model can suggest integrating the note with a corresponding document because the model determined that there was a common task related between the two. In some implementations, this process can be referred to as personalizing the model. In some instances, the models can be trained using unsupervised learning techniques, where the training data is not labeled, and correlations are found by the machine-learning training module 2404 independent of explicit labels applied prior to the machine-learning training. Some examples may see a combination of supervised and unsupervised methods in the same machine-learning training.

As one example, FIG. 26 illustrates a block diagram of an example training process 2600 in which training data 2602, which includes example input data 2604 that has labels 2606, is used to train a machine-learned model 2608. The machine-learned model 2608 creates output data 2610 (e.g., the priority group of notifications). Assume, as an example, that a user has a work task on which they have been focusing. During training for the model 2608 that the user interface application 106 or the notification manager 104 would utilize, the input data 2604 would consist of messages, notes, or other tasks that train the model 2608 to recognize patterns or correlations between software application data, such as a common task or a related project. Once the training is complete, the machine-learned model 2608 can be used to integrate content and prioritize notifications for the user. One example of this is that the machine-learned model 2608 can automatically associate a new message from a colleague with the current work task that the user has been focusing on. The machine-learned model 2608 is able to identify associations between notifications and applications through training data 2602 (e.g., prior user history). This integration allows easy access to all relevant information from applications of the user. Training processes other than the example process depicted in FIG. 26 can be used as well, including processes that do not use labels 2606.

The machine-learned model 2608 can be trained by optimizing an objective function 2612. For example, in some implementations, the objective function 2612 can be or include a loss function that compares (e.g., determines a difference between) the output data 2610 generated by the model 2608 from the training data 2602 and the labels 2606 (e.g., ground-truth labels) associated with the training data 2602. For example, the loss function can evaluate a sum or mean of squared differences between the output data 2610 and the labels 2606. As another example, the objective function 2612 can be or include a cost function that describes a cost of a certain outcome or output data. Other objective functions 2612 can include margin-based techniques such as, for example, triplet loss or maximum-margin training.

### Example Methods for Integrating Disparate Software Applications Through Inter-Process Communication Mechanisms

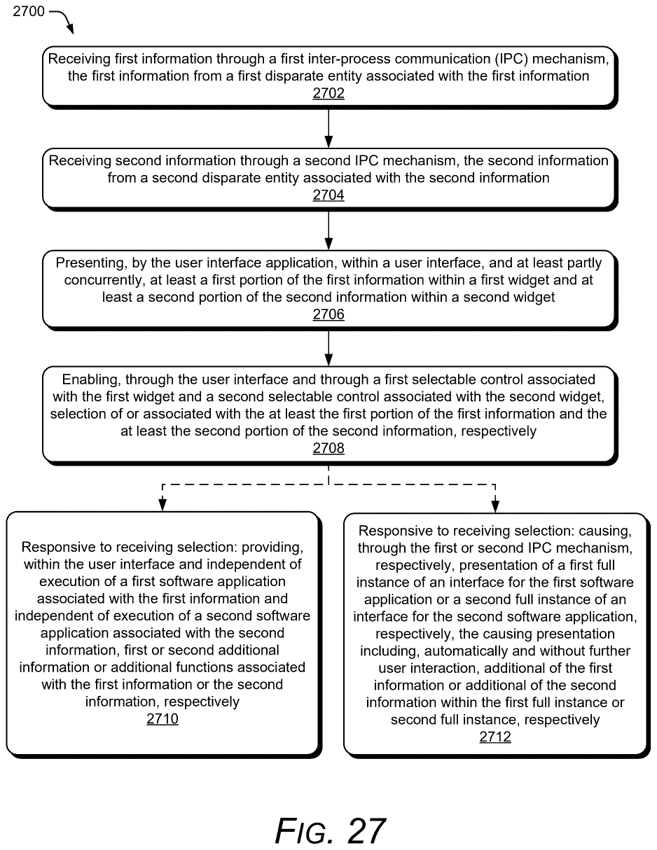

FIG. 27 depicts an example method 2700 for techniques enabling a user interface integrating disparate software applications through one or more inter-process communication mechanisms. The method 2700 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or to entities or processes as detailed in other figures, reference to which is made for example only. The techniques are not limited to performance by one entity or multiple entities operating on one device.

At 2702, a first information is received at a user interface application through a first inter-process communication (IPC) mechanism, the first information from a first disparate entity associated with the first information. As seen in FIG. 21, a user interface application 106 receives information 2106 from disparate entities 2104 through IPC mechanisms 2110. The information 2106 is associated with the disparate entities 2104. More specifically, the user interface application 106 receives first information 2106-1 from a first disparate entity 2104-1 through a first IPC mechanism 2110-1.

At 2704, a second information is received at a user interface application through a second IPC mechanism, the second information from a second disparate entity associated with the second information. As depicted in FIG. 21, the user interface application 106 receives a second information 2106-2 from a second disparate entity 2104-2 through a second IPC mechanism 2110-2.

At 2706, the user interface application presents, within a user interface, at least a first portion of the first information within a first widget and at least a second portion of the second information within a second widget. As seen in FIG. 21, the user interface application 106 presents a first portion of the first information 2106-1 within a first widget 2112-1 within a user interface 2108. The user interface application 106 may present information 2106-1, 2106-2, 2106-3, and 2106-4 concurrently (e.g., at a same time) or one-at-a-time. The user interface application 106 may also present the information 2106 in various orientations, such as illustrated in FIGS. 4 and 7-20. Thus, the user interface application 106 may present multiple widgets 2112 each separately within their own regions of the user interface 2108 or combined within a same region of the user interface. Furthermore, the user interface application 106 may present information in a format that differs from the format in which it would be presented in its associated software application's full user interface instance. Doing so, in some cases, can improve a user experience by making presentation of what would otherwise be disparate formats for information to be presented consistently.

At 2708, the user interface application enables selection of, or a control associated with, the at least the first portion of the first information and the at least the second portion of the second information, respectively, through the user interface and through a first selectable control associated with the first widget and a second selectable control associated with the second widget, respectively. As seen in FIG. 22, the user interface application 106 enables a user to select the first information 2106-1 through a first selectable control 2206-1 associated with the first widget 2112-1. Furthermore, the user interface application 106 enables the selection of information 2106-2, 2106-3, and 2106-4 through selectable controls 2206-2, 2206-3, and 2206-4, respectively.

In some cases, the disparate software applications include a similar function, such as a delete, zoom in/out, or reply function by which to delete text or an image portion, zoom in or out of text or images, or reply to a notification, respectively. In a case where full instances of each of the disparate software applications are instead presented, the user may need to find these similar functions and navigate to them at different locations, icons, selection manners, and so forth in disparate full instances for the disparate software applications. The user interface application 106, however, solves this poor user experience by enabling a control in a same location within the different widgets (e.g., an upper right corner of each of the first widget and the second widget), where the control enables the similar function. For example, selecting to cut, copy, or paste presented information in the widgets can be performed with a same user experience (e.g., a same icon and location) within each of the widgets.

Alternatively or in addition, a single control can be used for multiple of the widgets for a similar function, such as a single selectable image, icon, or button enabling performance of a function for one or more of the widgets. One example of such a manner is selecting to open a full instance with a single control within the user interface that presents multiple widgets and in which a last-interacted-with or most-recent update or change to a widget opens the full instance associated with that widget.

Both of these manners can save time and reduce user confusion, thereby improving the user experience. In cases, however, where a user may want to fully engage with a full instance of an interface for a software application associated with the information presented, the techniques enable selection to cause the full instance to be presented, such as shown in FIG. 23.

At 2710, the user interface application may provide, in response to receiving selection of the first selectable control or the second selectable control, first or second additional information or additional functions associated with the first information or second information, respectively. The user interface application provides the additional information within the user interface and independent of execution of a first software application associated with the first information and independent of execution of a second software application associated with the second information. As shown in FIG. 22, the user interface application 106 provides, within the user interface 2204, the additional information 2210 associated with the information 2106 once the selectable control 2206 has been selected.

Alternatively or in addition to 2710, at 2712, the user interface application causes presentation of a first full instance of an interface for the first software application or a second full instance of an interface for the second software application in response to the selection of the first selectable control. The user interface application automatically and without further user interaction causes the presentation of the additional first information or the additional second information within the first full instance or the second full instance, respectively. Furthermore, causing presentation of the first full instance of an interface for the first software application can present the first full instance within the user interface (e.g., replacing much or all of the user interface area currently presented by the user interface application 106) or separately, such as in a new window. As noted in part above, the presentation of the first full instance of an interface for the first software application within the user interface (e.g., the user interface 602, 910, 1502, or 2302) may include communication with the associated disparate entity or software application.

This can be performed in part through use of the IPC mechanisms, such as by the user interface 106 passing the selection and/or the information or function selected to the disparate entity associated with the software application capable of presenting the first full instance. As seen in FIG. 23, the user interface application 106 causes presentation of a first full instance 2304 of a first software application 2306 through the first IPC mechanism 2110-1 in response to the user selecting the first selectable control 2206-1 within the user interface 2302. The user interface application 106 automatically presents the first information 2106-1 and the first additional information 2210-1 within the first full instance 2304. Thus, with a single selection, the techniques enable a user to select information or a function for that information for presentation in the full instance. The user does not need to separately open/launch the appropriate full instance of the interface and the information or function to be presented or performed. Instead, this is performed by the user interface application 106 responsive to the above selection (e.g., the user selection 2208 of FIG. 22).

### Example Methods Enabling Simplified and Integrated Interaction with Multiple Applications

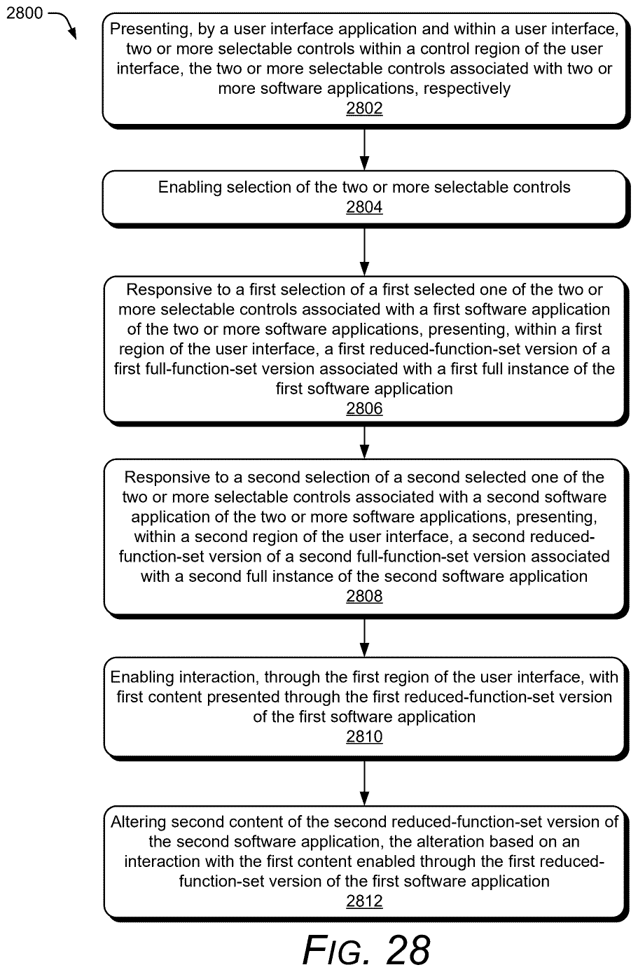

FIG. 28 depicts an example method 2800 for techniques enabling a user interface for simplified and integrated interaction with multiple applications. The method 2800 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or to entities or processes as detailed in other figures, reference to which is made for example only. The techniques are not limited to performance by one entity or multiple entities operating on one device.

At 2802, two or more selectable controls within a control region of a user interface are presented by a user interface application within the user interface, the two or more selectable controls associated with two or more software applications respectively. As seen in FIG. 2, the user interface application 106 presents the three selectable controls 206, 208, and 210 within the user interface 202. The three selectable controls 206, 208, and 210 are within the control region 204 within the user interface 202 and are associated with the first, second, and third associated software applications 212, 214, and 216. The three associated software applications 212, 214, and 216 are provided by the user interface application 106.

At 2804, the user interface application may enable selection of the two or more selectable controls. As seen in FIG. 2, the user interface application 106 enables the selection of the three selectable controls 206, 208, and 210 within the control region 204. A cursor is depicted in FIG. 2 to illustrate the user interface application 106 enabling selection.

At 2806, responsive to a first selection of a first selectable control, the user interface application presents a first reduced-function-set version of a first full-function-set version associated with a first full instance of an interface for a first software application. As depicted in FIG. 12, the first full-function-set version 1210 and the first reduced-function-set version 1212 are presented in the user interface 1214 by the user interface application 106 and are associated to the first software application 1202 (e.g., calendar application 1202). The reduced-function-set version 1212 is smaller than the full-function-set version 1210. As illustrated, the full-function-set version 1210 includes additional content, greater size and resolution, and additional features.

At 2808, responsive to a second selection of a second selectable control, the user interface application presents a second reduced-function-set version of a second full-function-set version associated with a second full instance of an interface for a second software application. As seen in FIG. 13, the user interface application 106 presents the second reduced-function-set version 1308 associated with the software application 1316 (e.g., notes application 1316). Also included is the smaller reduced-function-set version 1310 that shows some of the possible size ranges of reduced-function-set versions.

At 2810, the user interface application enables interaction with a first content presented through the first reduced-function-set version of the first software application, as seen in FIGS. 6-10 and 12-15.

At 2812, the user interface application alters a second content of the second reduced-function-set version of the second software application, the alteration based on an interaction with the first content enabled through the first reduced-function-set version of the first software application. As illustrated in FIG. 6 (and other figures), the user interface application 106 alters content that is in the two separate but associated software applications 612 and 614. There is the first content 604 within the first reduced-function-set version 608 associated with the first software application 612, and there is the second content 606 within the second reduced-function-set version 610 associated with the second software application 614. The first content 604 has been altered by the user, and since the first and second software applications 612 and 614 are associated with each other, the second content 606 is automatically altered by the user interface application 106, and the change is presented in the second reduced-function-set version 610 associated with the second software application 614. For example, a user may want to delete a certain aspect of their notes from a meeting. When selected by the user, not only will content (e.g., first content 604) in a notes application (e.g., first software application 612) be changed immediately by the user interface application, but also content (e.g., second content 606) within a team meeting application (e.g., second software application 614) will be automatically adjusted to align with the alteration in the content from the notes application.

### Example Methods Enabling a Multi-application User Interface for Prioritizing Notifications

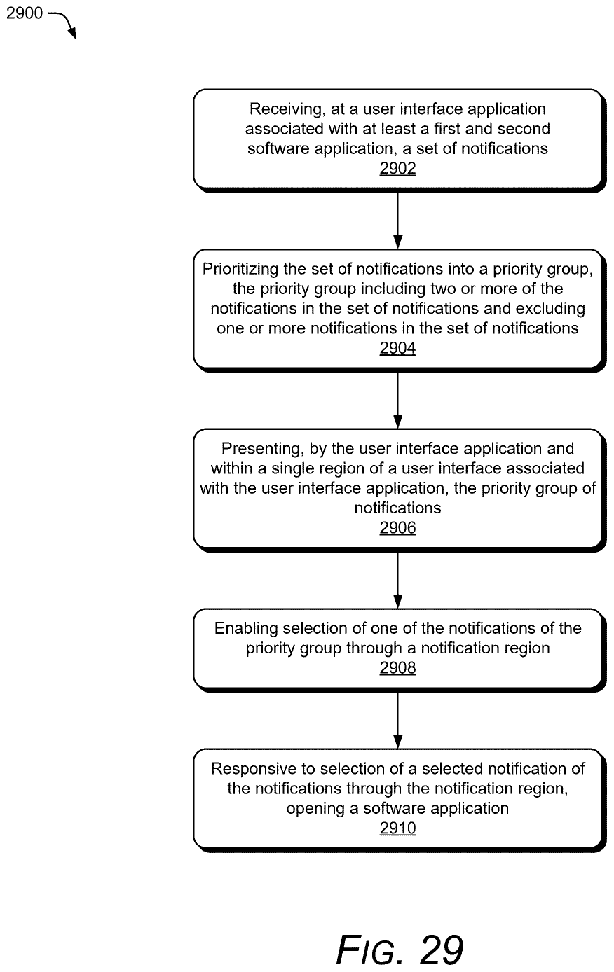

FIG. 29 depicts an example method 2900 for techniques enabling a multi-application user interface for prioritizing notifications. The method 2900 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example operating environment 1600 of FIG. 16 or to entities or processes as detailed in other figures, reference to which is made for example only. The techniques are not limited to performance by one entity or multiple entities operating on one device.

At 2902, a set of notifications are received at a user interface application, the set of notifications associated with at least a first and second software application. As seen in FIG. 16, the notification manager 104 receives notifications from at least two applications 1602. As illustrated, four applications 1602 have sixteen different notifications. The email application 1602-1 has four notifications, the SMS application 1602-2 has three notifications, the calendar application 1602-3 has two notifications, and the social media application 1602-4 has seven notifications. The notification manager 104 is configured to interact with multiple applications 1602, such as by receiving the notifications over a time period as a group from each application 1602, although they can come in separately and/or periodically. The notification manager 104 may receive notifications in different ways, including, but not limited to, push notifications, API notifications, passive notifications, local notifications, and in-app notifications.

At 2904, the set of notifications are prioritized into a priority group. The priority group includes two or more of the notifications in the set of notifications and excludes one or more of the notifications in the set of notifications. The notification manager 104 determines priority based on a relation between notifications, a disparate importance of notifications, a machine-learned model, or prior user selection, such as the illustrated priority group of five or six notifications from the set of sixteen notifications (FIGS. 16 and 20, respectively).

For example, the notification manager 104 may prioritize a set of notifications based on relationships between the set of notifications. The set of notifications has a relation between notifications based on the notifications being related to a single project, such as a substance-based task associated with both the first and second applications. The notification manager 104, for example, can determine the single project based on a history of application usage by a user. For example, the application usage may indicate greater use of one of the first and second applications than the other, or greater use between other applications also associated with the described user interface and the set of notifications. Furthermore, the notification manager 104 may prioritize the set of notifications based on notifications being associated with a same work project, such as through analysis of metadata and/or text within the notifications indicating a relation to a topic or project (e.g., a work project that requires the user to travel and meet with a person named “Bill”) as the notifications share a common term, metadata, or person.

In other aspects, the notification manager 104 may prioritize the set of notifications based on the disparate importance of notifications within the set of notifications. The notification manager 104 determines the disparate importance based on a due date to respond, which is determined from within text of the notifications or metadata associated with the notifications.

In other instances, the notification manager 104 may prioritize the set of notifications into the priority group based on prior user selection, such as the user associating the first and second applications to a project, or based on the user arranging the user interface 1604 (e.g., arranging reduced-function-set versions into the user interface 1604 for a work calendar application, a work email application, and a social media account associated with work). The user may arrange the user interface 1604 by selecting reduced-function-set versions for presentation on a home page of the user interface 1604, adjusting their size, and so forth. The reduced-function-set versions may be associated with the first and second applications (e.g., as illustrated in FIGS. 16 and 20). The notification manager 104 may also prioritize the set of notifications into the priority group based on a shared project name, a common group of employees and/or vendors, or various metadata about some of the notifications.

The process of prioritizing the set of notifications eliminates some notification(s) from the set, leaving the priority group. The notification manager 104 may remove notifications from the set of notifications based on an age of a removed notification. The age of the removed notification may be older than one of the remaining notifications, and removed notification and the remaining notification may be related through a common group, task, or project or a single application of the first and second applications. For example, the notifications of the set of notifications may include an email, an SMS message or a text, information received through an API, a push notification, a social-media like, a social-media mention, a tag, a calendar event, a missed video chat, or a missed phone call.

At 2906, the priority group of notifications is presented by the user interface application and within a single region of a user interface. The priority group can be presented as shown in FIGS. 17, 18, 19, or 20. The priority group of notifications can be within the single region of the user interface or within a reduced-function-set version region (e.g., priority notification region 2002 of FIG. 20). The user interface application occupies a substantial majority of a display of a mobile electronic device, such as a touch-sensitive display of a smartphone or tablet, and is of a sufficient size with larger displays to cover multiple regions having at least one notification region.

At 2908, the user interface application may enable selection, through a notification region, of one of the notifications of the priority group. Responsive to the selection of the selected notification of the notifications through the notification region, the notification manager 104 can open or access a software application associated with the selected notification (e.g., the notification was received, at operation 2902, from the software application or a server entity associated with the software application). The user interface application 106 (as shown in FIG. 16) may cause the software application to open a notification user interface showing additional information for the notification, providing the additional information to the user interface application for presentation in another region (e.g., notification pop-up region 1802 of FIG. 18). Furthermore, the user interface application 106 may cease to present the notification within the region commensurate with the presented additional information within the reduced-function-set version region (e.g., application reduced-function-set version region 1902 of FIG. 19).

In aspects, a notification of the priority group of notifications is an email notification. The presented priority group of notifications may be a portion of an email associated with the email notification. Furthermore, responsive to the selection of the notification, the user interface may present an additional portion of the email. The additional portion of the email may be substantially all the text of the email, presented within an expanded portion of the user interface, a reduced-function-set version associated with an email service application and within the user interface, or a user interface of the email service application. In other aspects, a notification of the priority group of notifications may be an SMS notification, a social media notification, a task management notification, a productivity notification, a calendar notification, a document editing notification, a video conferencing notification, a phone call notification, or a collaboration update notification.

As noted above, the user interface can enable the selection of one of the notifications of the priority group through the single region, such as the priority notification region 1702 in FIG. 17.

At 2910, responsive to the selection of the notification, the user interface application directs a software application associated with the selected notification to be opened, launched, installed, accessed, or otherwise utilized or simulated. By so doing, the software application, or the user interface 1604 acting as a simulation, is directed to open a notification user interface, such as the application reduced-function-set version region 1902 of FIG. 19.

Throughout this disclosure, examples are described where a computing system (e.g., the UE 102 of FIG. 1, a client device, a server device, a computer, or another type of computing system) may analyze information (e.g., disparate software application data) associated with a user, for example, the disparate software applications mentioned with respect to FIG. 21. Further to the descriptions above, a user may be provided with controls allowing the user to make an election as to both if and when systems, programs, and/or features described herein may enable collection of information (e.g., content associated with a user's applications, such as notifications, user behavior, and other information). The computing system can be configured to only use the information after it receives explicit permission from the user to use the data. Further, individual users may have constant control over what programs can or cannot do with the information. In addition, information collected may be pre-treated in one or more ways before it is transferred, stored, or otherwise used, so that personally-identifiable information is removed. For example, a user's identity may be treated so that no personally identifiable information can be determined for the user, or a user's geographic location may be generalized where location information is obtained (for example, to a city, ZIP code, or state level), so that a particular location of a user cannot be determined. Thus, the user may have control over whether information is collected about the user and the user's device, and how such information, if collected, may be used by the computing device and/or a remote computing system.

### EXAMPLES

Various examples are described herein, including a first example method (example 1) that receives, at a user interface application associated with at least a first and second software application, a set of notifications. The set of notifications include one or more first notifications associated with the first software application and one or more second notifications associated with the second software application. The method prioritizes the set of notifications into a priority group, the priority group including two or more of the notifications in the set of notifications and excluding one or more of the notifications in the set of notifications. The method prioritizes based on a relation between and a disparate importance of notifications within the set of notifications. The method may then present or cause presentation of, through the user interface application and within a single region of the user interface, the priority group of notifications.

Example 2: The method of example 1, wherein a notification of the priority group of notifications is an email notification and the presenting the priority group of notifications presents a portion of an email associated with the email notification, and further comprising, responsive to selection of the notification, presenting an additional portion of the email.

Example 3: The method of example 2, wherein presenting the additional portion of the email presents substantially all text of the email, the presenting within an expanded portion of the user interface, a reduced-function-set version associated with an email service application and within the user interface, or a user interface of the email service application.

Example 4: The method of example 1, wherein a notification of the priority group of notifications is an SMS notification and the presenting the priority group of notifications presents a portion of an SMS associated with the SMS notification, and further comprising, responsive to selection of the notification, presenting an additional portion of the SMS.

Example 5: The method of example 4, wherein presenting the additional portion of the SMS presents substantially all text of the SMS, the presenting within an expanded portion of the user interface, a reduced-function-set version associated with an SMS service application and within the user interface, or a user interface of the SMS service application.

Example 6: The method of example 1, wherein a notification of the priority group of notifications is a social media notification and the presenting the priority group of notifications presents a portion of a social media associated with the social media notification, and further comprising, responsive to selection of the notification, presenting an additional portion of the social media.

Example 7: The method of example 6, wherein presenting the additional portion of the social media presents substantially all text of the social media, the presenting within an expanded portion of the user interface, a reduced-function-set version associated with a social media service application and within the user interface, or a user interface of the social media service application.

Example 8: The method of any one of the preceding examples, wherein the set of notifications are received over a time period and through a push notification from the first and second software applications.

Example 9: The method of example 1, wherein the prioritizing the set of notifications into the priority group removes notifications from the set of notifications, remaining notifications of the set of notifications being the priority group.

Example 10: The method of example 9, wherein the removal of the notifications from the set of notifications is based on an age of a removed notification, the age being older than an age of one of the remaining notifications, the removed notification and the remaining notification related through a common group, task, or project or a single software application of the first and second software applications.

Example 11: The method of example 1, wherein the first software application is a calendar application, a first related notification is a calendar event associated with a project, the second software application is an information-generation application, and a second related notification is a change-made, change-requested, or approval-requested notification for an information document of the information-gathering application that is associated with the first related notification.

Example 12: The method of example 1, wherein the first software application is a social media application, a first related notification is a new message, like, comment, follow, post, or tag of the social media application that is associated with a project, the second software application is a task management application, and a second related notification is a task reminder, task assignment, task update, or task comment associated with a task of the task management application that is associated with the first related notification.

Example 13: The method of example 1, wherein the first software application is an email application, a first related notification is a new email, email delivery failure, calendar invitation, or meeting reminder associated with a project, the second software application is a contact management application, and a second related notification is a new contact, contact deletion, contact update, or lead status associated with the first related notification.

Example 14: The method of example 1, wherein the first software application is an email application, a first related notification is a new email, email delivery failure, calendar invitation, or meeting reminder associated with a project, the second software application is a writing-enhancing application, and a second related notification is a sentence structure suggestion, tone and formality suggestion, or vocabulary enhancement suggestion associated with the first related notification.

Example 15: The method of example 1, wherein the first software application is a document editing application, a first related notification is an update, a new comment, or changes made by other users associated with a project, the second software application is a writing-enhancing application, and a second related notification is a plagiarism alert, writing style suggestion, clarity and conciseness suggestion, or grammar and spelling error alert associated with the first related notification.

Example 16: The method of example 1, wherein the first software application is a customer relationship management application, a first related notification is a customer activity or team activity alert associated with a project, the second software application is a user authentication application, and a second related notification is a login, security alert, or privacy alert associated with the first related notification.

Example 17: The method of example 1, wherein the first software application is a notes application, a first related notification is a reminder, collaboration update, or sync update associated with a project, the second software application is a mind-mapping application, and a second related notification is a new diagram or an updated diagram integrating notes associated with the first related notification.

Example 18: The method of example 1, wherein the first software application is an SMS application, a first related notification is a new SMS message, an SMS read receipt, group updates, SMS delivery, SMS delivery failures, or spam alerts associated with a project, the second software application is a project management application, and a second related notification is a new task or calendar reminder, new activity, or collaboration alert associated with the first related notification.

Example 19: The method of example 1, wherein the first software application is a video conferencing application, a first related notification is a meeting reminder or invitation associated with a project, the second software application is an automated note-taking application, and a second related notification is a new note alert, note updated, note shared, or collaboration alert associated with the first related notification.

Example 20: The method of example 1, wherein the prioritizing based on the relation between and the disparate importance of notifications within the set of notifications uses a machine-learned model.

Example 21: The method of example 20, wherein the machine-learned model is built based on a history of user behavior.

Example 22: The method of any one of examples 1 to 21, wherein the prioritizing the set of notifications into the priority group is based on prior user selection associating the first and second applications to a project.

Example 23: A computer-readable storage media comprising instructions that, responsive to execution by a processor, cause the processor to perform any one of the methods of examples 1 to 22.

Example 24: An electronic computing device comprising at least one processor and computer-readable storage media comprising instructions that, responsive to execution by the at least one processor, direct the electronic computing device to perform any one of the methods of examples 1 to 22.

Various examples are described herein, including a first example method (example 25) that performs operations including presenting, by a user interface application and within a user interface, two or more selectable controls within a control region of the user interface, the two or more selectable controls associated with two or more software applications, respectively. The example method then performs operations including enabling selection of the two or more selectable controls and, responsive to a first selection of a first selected one of the two or more selectable controls associated with a first software application of the two or more software applications, presenting, within a first region of the user interface, a first reduced-function-set version of a first full-function-set version associated with a first full instance of the first software application. The example method, responsive to a second selection of a second selected one of the two or more selectable controls associated with a second software application of the two or more software applications, then performs an operation of presenting, within a second region of the user interface, a second reduced-function-set version of a second full-function-set version associated with a second full instance of the second software application. The example method further includes enabling interaction, through the first region of the user interface, with first content presented through the first reduced-function-set version of the first software application and altering second content of the second reduced-function-set version of the second software application, the alteration based on an interaction with the first content enabled through the first reduced-function-set version of the first software application.

Example 26: The method of example 25, further comprising, responsive to selection of the first region or the first selectable control, altering a size or orientation of both the first and the second region.

Example 27: The method of example 26, wherein the altering the size or orientation of both of the first and second regions automatically alters the second region without user interaction or selection of the second region.

Example 28: The method of example 25, wherein altering the second content of the second reduced-function-set version of the second software application is based on a prior association between the first and second software applications.

Example 29: The method of example 28, wherein the prior association is based on an explicit user selection to associate the first and second software applications with a substance-based task.

Example 30: The method of example 28, wherein the prior association is based on an implicit user selection to associate the first and second software applications through selection to orient the first and second applications within the user interface.

Example 31: The method of example 25, wherein altering the second content of the second reduced-function-set version of the second software application is based on an explicit user selection enabled through a selectable user control associated with the first or second region.

Example 32: The method of example 25, wherein altering the second content is responsive to the interaction, the interaction with the first content presented through the first reduced-function-set version of the first software application.

Example 33: The method of example 32, wherein the interaction with the first content adds, deletes, or changes the first content, and wherein the alteration to the second content adds, deletes, or changes the second content.

Example 34: The method of example 32, further comprising passing information associated with the interaction with the first content to the second software application, and wherein altering the second content of the second reduced-function-set version of the second software application is responsive to information received from the second software application in response to the passing the information to the second software application.

Example 35: The method of example 25, further comprising passing information associated with the interaction with the first content to the second software application; receiving a change or notification received from the second software application, the change or notification based on the information associated with the interaction; and presenting the received change or notification within the user interface.

Example 36: The method of example 25, further comprising presenting, responsive to an initial selection or intermediate selection of the first control of the two or more selectable controls, one or more instances of content or functions associated with the first software application; enabling selection of the one or more instances of content or functions associated with the first software application; and receiving selection of a selected one of the one or more instances, and wherein the presenting within the first region of the user interface the first reduced-function-set version presents the selected one of the one or more instances.

Example 37: The method of example 36, wherein presenting the one or more instances of content or functions associated with the first software application presents reduced-size, reduced-resolution, reduced-function, or reduced-content versions of the one or more instances of content or functions.

Example 38: The method of example 37, wherein the presenting the one or more instances of content or functions associated with the first software application presents one-at-a-time.

Example 39: The method of example 25, wherein enabling selection of the two or more selectable controls enables selection of a drag-and-drop of the first selected control into the user interface wherein the presenting is responsive to the drag-and-drop of the first selected control.

Example 40: The method of example 25, wherein the first and second regions are of different sizes and locations within the user interface, and wherein enabling selection of the two or more selectable controls enables selection of regions of different sizes, and wherein presenting the first reduced-function set version within the first region is responsive to selection of the first region.

Example 41: The method of example 40, wherein the first region is larger than the second region, and wherein presenting the first reduced-function set version within the first region presents additional content relative to presentation in the second region.

Example 42: The method of example 41, wherein the first region is larger than the second region, and wherein presenting the first reduced-function set version within the first region enables additional functions relative to presentation in the second region.

Example 43: The method of example 25, wherein the first reduced-function-set version is a reduced-function-set version, borderless window, active control, thumbnail, or applet and the first full instance of the first software application is a full function instance associated with an executing instance of the first software application.

Example 44: The method of example 25, wherein the first content comprises one or more selectable functions of the first reduced-function-set version of the first software application; the enabling interaction with the first content enables selection of the one or more selectable functions; and altering the second content of the second reduced-function-set version of the second software application is based on the first selection of a first selected one of the one or more selectable functions of the first reduced-function-set version of the first software application.

Example 45: The method of example 25, wherein: the first content comprises visual information presented within the first reduced-function-set version of the first software application; the enabling interaction with the first content enables alteration of the visual information; and altering the second content of the second reduced-function-set version of the second software application is based on a selected alteration to the visual information presented within the first reduced-function-set version of the first software application.

Example 46: The method of example 45, wherein the visual information comprises a portion or all of an email, an SMS message, a social-media comment, a calendar event, a word-processing document, or an image.

Example 47: The method of example 25, wherein altering the second content of the second reduced-function-set version of the second software application based on the interaction with the first content enabled through the first reduced-function-set version of the first software application alters the second content based on a machine-learned model.

Example 48: The method of example 47, wherein the machine-learned model is based on a history of prior user behavior, the history of prior user behavior used as truth data to train the machine-learned model.

Example 49: The method of example 48, wherein the prior user behavior includes prior interactions, by a user from which the interaction with the first content is received, with the second content.

Example 50: A computer-readable storage media comprising instructions that, responsive to execution by a processor, cause the processor to perform any one of the methods of examples 25-49, singly or in combination.

Example 51: An electronic computing device comprising at least one processor and computer-readable storage media comprising instructions that, responsive to execution by the at least one processor, direct the electronic computing device to perform any one of the methods of examples 25-49, singly or in combination.

Various examples are described herein, including example method 52 that performs operations including receiving, by a user interface application, first information through a first inter-process communication (IPC) mechanism, the first information from a first disparate entity associated with the first information and receiving second information through a second IPC mechanism, the second information from a second disparate entity associated with the second information. The example method then performs an operation of presenting, by a user interface application, within a user interface, and at least partly concurrently, at least a first portion of the first information within a first widget and at least a second portion of the second information within a second widget. The example method then performs an operation including enabling, through the user interface and through a first selectable control associated with the first widget and a second selectable control associated with the second widget, selection of or associated with the at least the first portion of the first information and the at least the second portion of the second information, respectively. The example method, responsive to receiving the selection, then performs an operation of providing, within the user interface and independent of execution of a first disparate software application associated with the first information and independent of execution of a second disparate software application associated with the second information, first or second additional information or additional functions associated with the first information or the second information, respectively. Alternatively, the example method, responsive to receiving the selection, then causes presentation of a first full instance of an interface for the first disparate software application or a second full instance of an interface for the second disparate software application, respectively, the causing presentation including, automatically and without further user interaction, the first or second additional information or an additional function associated with the first information or the second information, respectively, within the first full instance or the second full instance, respectively.

Example 53: The method of example 52, wherein the first widget is a first reduced-function-set version of the first full instance, the first widget being a borderless window, active control, or thumbnail.

Example 54: The method of example 52 or 53, wherein causing presentation of the first full instance of the interface for the first disparate software application presents the first full instance within the user interface.

Example 55: The method of any one of examples 52 to 54, wherein responsive to receiving the selection of the first selectable control or the second selectable control comprises providing the first or second additional information or the additional function associated with the first information or the second information, respectively.

Example 56: The method of any one of examples 52 to 55, wherein the presenting presents the at least the first portion of the first information within the first widget and the at least the second portion of the second information within the second widget, the presenting within a same region of the user interface.

Example 57: The method of any one of examples 52 to 56, wherein presenting the at least the first portion of the first information within the first widget presents in an altered format, the altered format different from a format in which the interface for the first disparate software application is configured to present the first information.

Example 58: The method of any one of examples 52 to 57, wherein the first and second IPC mechanisms are different IPC mechanisms, the first IPC mechanism being an application programming interface, a remote procedure call, a message queue, a simple object access protocol, a hypertext transfer protocol, or a file-based communication.

Example 59: The method of any one of examples 52 to 58, wherein responsive to receiving selection of the first selectable control or the second selectable control comprises causing, through the first or second IPC mechanism, respectively, presentation of the first full instance of the interface for the first disparate software application or the second full instance of the interface for the second disparate software application, respectively, the causing presentation including, automatically and without further user interaction, additional of the first information or additional of the second information within the first full instance or the second full instance, respectively.

Example 60: The method of any one of examples 52 to 59, wherein the first or the second information is a notification associated with the first or second disparate software application, respectively.

Example 61: The method of example 60, wherein presenting the at least the first portion of the first information within the first widget or the at least the second portion of the second information within the second widget presents within a notification region of the user interface.

Example 62: The method of any one of examples 52 to 61, wherein causing presentation of the first full instance of the interface for the first disparate software application within the user interface comprises passing, through the first IPC mechanism, an indication of the selection to the first disparate entity.

Example 63: The method of any one of examples 52 to 62, wherein the first disparate software application and the second disparate software application include a similar function, the similar function displayed having disparate visual controls in the first full instance of the interface for the first disparate software application and the second full instance of the interface for the second disparate software application, and wherein the method enables a control having a same visual control in the first widget and the second widget, the same visual control enabling the similar function for either of the first and second disparate software applications or their associated widgets.

Example 64: The method of example 63, wherein the similar function is a delete text or image portion function, a zoom in or zoom out function, or a reply function, the reply function associated with the first or second information, respectively.

Example 65: A computer-readable storage media comprising instructions that, responsive to execution by a processor, cause the processor to perform any one of the methods of examples 52 to 64.

Example 66: An electronic computing device comprising at least one processor and computer-readable storage media comprising instructions that, responsive to execution by the at least one processor, direct the electronic computing device to perform any one of the methods of examples 52 to 64.

### Conclusion

Although implementations of techniques for, and apparatuses enabling, a user interface for simplified and integrated interaction with multiple applications have been described in language specific to features and/or methods, it is to be understood that the subject of the appended claims is not necessarily limited to the specific features or methods described. Rather, the specific features and methods are disclosed as example implementations enabling a user interface for simplified and integrated interaction with multiple applications.

1. A method comprising:
presenting, by a user interface application and within a user interface, two or more selectable controls within a control region of the user interface, the two or more selectable controls associated with two or more software applications, respectively;
enabling selection of the two or more selectable controls;
responsive to a first selection of a first selected one of the two or more selectable controls associated with a first software application of the two or more software applications, presenting, within a first region of the user interface, a first reduced-function-set version of a first full-function-set version associated with a first full instance of the first software application;
responsive to a second selection of a second selected one of the two or more selectable controls associated with a second software application of the two or more software applications, presenting, within a second region of the user interface, a second reduced-function-set version of a second full-function-set version associated with a second full instance of the second software application;
enabling interaction, through the first region of the user interface, with first content presented through the first reduced-function-set version of the first software application; and
altering second content of the second reduced-function-set version of the second software application, the alteration based on an interaction with the first content enabled through the first reduced-function-set version of the first software application.

2. The method of claim 1, wherein altering the second content of the second reduced-function-set version of the second software application is based on a prior association between the first and second software applications, the prior association based on an explicit user selection to associate the first and second software applications with a substance-based task.

3. The method of claim 1, further comprising passing information associated with the interaction with the first content to the second software application, and wherein altering the second content of the second reduced-function-set version of the second software application is responsive to information received from the second software application in response to the passing the information to the second software application.

4. The method of claim 3, further comprising receiving the received information from the second application, and wherein the passing information and the receiving information is through an inter-process communication mechanism, the inter-process communication mechanism including an application programming interface, a remote procedure call, a message queue, a simple object access protocol, a hypertext transfer protocol, or a file-based communication.

5. The method of claim 1, further comprising:
responsive to an initial selection or intermediate selection of the first control of the two or more selectable controls, presenting one or more instances of content or functions associated with the first software application;
enabling selection of the one or more instances of content or functions associated with the first software application; and
receiving selection of a selected one of the one or more instances, and
wherein the presenting within the first region of the user interface the first reduced-function-set version presents the selected one of the one or more instances.

6. The method of claim 5, wherein presenting the one or more instances of content or functions associated with the first software application presents reduced-size, reduced-resolution, reduced-function, or reduced-content versions of the one or more instances of content or functions.

7. The method of claim 1, wherein the first and second regions are of different sizes and locations within the user interface, and wherein enabling selection of the two or more selectable controls enables selection of regions of different sizes, and wherein presenting the first reduced-function set version within the first region is responsive to selection of the first region.

8. The method of claim 7, the first region is larger than the second region, and wherein presenting the first reduced-function set version within the first region enables additional functions relative to presentation in the second region.

9. The method of claim 1, wherein the first reduced-function-set version is a reduced-function-set version, borderless window, active control, thumbnail, or applet and the first full instance of the first software application is a full function instance associated with an executing instance of the first software application.

10. The method of claim 1, wherein:
the first content comprises one or more selectable functions of the first reduced-function-set version of the first software application;
the enabling interaction with the first content enables selection of the one or more selectable functions; and
altering the second content of the second reduced-function-set version of the second software application is based on the first selection of a first selected one of the one or more selectable functions of the first reduced-function-set version of the first software application.

11. The method of claim 1, wherein:
the first content comprises visual information presented within the first reduced-function-set version of the first software application;
the enabling interaction with the first content enables alteration of the visual information, the visual information comprises a portion or all of an email, an SMS message, a social-media comment, a calendar event, a word-processing document, or an image; and
altering the second content of the second reduced-function-set version of the second software application is based on a selected alteration to the visual information presented within the first reduced-function-set version of the first software application.

12. The method of claim 1, wherein altering the second content of the second reduced-function-set version of the second software application based on the interaction with the first content enabled through the first reduced-function-set version of the first software application alters the second content based on a machine-learned model.

13. The method of claim 12, wherein the machine-learned model is based on a history of prior user behavior, the history of prior user behavior used as truth data to train the machine-learned model.

14. A computer-readable storage media comprising instructions that, when executed by one or more processors, configure at least one processor of the one or more processors to:
present, by a user interface application and within a user interface, two or more selectable controls within a control region of the user interface, the two or more selectable controls associated with two or more software applications, respectively;
enable selection of the two or more selectable controls;
responsive to a first selection of a first selected one of the two or more selectable controls associated with a first software application of the two or more software applications, present, within a first region of the user interface, a first reduced-function-set version of a first full-function-set version associated with a first full instance of the first software application;
responsive to a second selection of a second selected one of the two or more selectable controls associated with a second software application of the two or more software applications, present, within a second region of the user interface, a second reduced-function-set version of a second full-function-set version associated with a second full instance of the second software application;
enable interaction, through the first region of the user interface, with first content presented through the first reduced-function-set version of the first software application; and
alter second content of the second reduced-function-set version of the second software application, the alteration based on an interaction with the first content enabled through the first reduced-function-set version of the first software application.

15. (canceled)

16. The computer-readable storage media of claim 14, wherein altering the second content of the second reduced-function-set version of the second software application is based on a prior association between the first and second software applications, the prior association based on an explicit user selection to associate the first and second software applications with a substance-based task.

17. The computer-readable storage media of claim 14, wherein the instructions, when executed, further configure the at least one processor to pass information associated with the interaction with the first content to the second software application, and wherein altering the second content of the second reduced-function-set version of the second software application is responsive to information received from the second software application in response to the passing the information to the second software application.

18. The computer-readable storage media of claim 14, wherein the instructions, when executed, further configure the at least one processor to receive the received information from the second application, and wherein the passing information and the receiving information is through an inter-process communication mechanism, the inter-process communication mechanism including an application programming interface, a remote procedure call, a message queue, a simple object access protocol, a hypertext transfer protocol, or a file-based communication.

19. The computer-readable storage media of claim 14, wherein the instructions, when executed, further configure the at least one processor to:
responsive to an initial selection or intermediate selection of the first control of the two or more selectable controls, present one or more instances of content or functions associated with the first software application;
enable selection of the one or more instances of content or functions associated with the first software application; and
receive selection of a selected one of the one or more instances, and
wherein the presenting within the first region of the user interface the first reduced-function-set version presents the selected one of the one or more instances.

20. The computer-readable storage media of claim 14, wherein:
the first reduced-function-set version is a reduced-function-set version, borderless window, active control, thumbnail, or applet and the first full instance of the first software application is a full function instance associated with an executing instance of the first software application;
the first content comprises one or more selectable functions of the first reduced-function-set version of the first software application;
the enabling interaction with the first content enables selection of the one or more selectable functions; and
altering the second content of the second reduced-function-set version of the second software application is based on the first selection of a first selected one of the one or more selectable functions of the first reduced-function-set version of the first software application.

21. The computer-readable storage media of claim 14, wherein:
altering the second content of the second reduced-function-set version of the second software application based on the interaction with the first content enabled through the first reduced-function-set version of the first software application alters the second content based on a machine-learned model; and
the machine-learned model is based on a history of prior user behavior, the history of prior user behavior used as truth data to train the machine-learned model.
